(19) United States
(12) Patent Application Publication
(10) Pub. No.: US 2026/0289148 A1
(43) Pub. Date: Sep. 24, 2026

(54) SYSTEM

(71) Applicant: SoftBank Group Corp., Tokyo (JP)

(72) Inventor: Yuki KOJIMA, Tokyo (JP)

(73) Assignee: SoftBank Group Corp., Tokyo (JP)

(21) Appl. No.: 19/567,338

(22) Filed: Mar. 16, 2026

(30) Foreign Application Priority Data
Mar. 19, 2025 (JP) 2025-045247

(51) Int. Cl. G06F 40/35; G06N 3/0475

(52) U.S. Cl. CPC G06F 40/35; G06N 3/0475

(57) ABSTRACT

A system includes a processor that is configured to collect historical performance information, market trend information, and competitor information, convert the collected data into a format suitable for analysis, analyze the data using a machine learning algorithm to identify factors that affect a management strategy, generate an optimal management strategy by using a generative AI model based on the identified factors, obtain emotion information by using an emotion engine that recognizes a user's emotion, and reflect the obtained emotion information in the generated management strategy, and receive feedback from a user and use the feedback to improve the generative AI model.

### CROSS-REFERENCE TO RELATED APPLICATION

This application is based on and claims priority under 35 USC 119 from Japanese Patent Application No. 2025-045247 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional management support systems and decision-support tools are mainly designed to provide analytical reports, dashboards, and static recommendations based on past performance data and market information. In such systems, the processor generally analyzes numerical data and generates reports, but does not generate an integrated and optimized management strategy in an autonomous and adaptive manner. Furthermore, existing systems rarely employ generative AI models to create comprehensive management strategies that explicitly reflect both objective business factors and subjective user emotions. As a result, the generated strategies tend to be limited to rule-based or template-based outputs that lack flexibility, creativity, and personalization toward individual management teams. Additionally, conventional systems do not sufficiently incorporate user feedback into an iterative improvement cycle of the underlying AI models, and therefore have limited capability to adapt to changes in the business environment, management philosophy, and organizational culture. Emotional aspects of users, such as risk tolerance, strategic preferences, and psychological reactions to market conditions, are generally ignored, which can lead to a mismatch between AI-generated recommendations and the actual intentions or acceptance levels of human management members. Consequently, there is a need for a system that can collect and analyze diverse business data, generate optimal management strategies using a generative AI model, dynamically reflect user emotions in the strategy, and continuously improve the generative AI model based on user feedback.

Moreover, when such an AI-based system is introduced into an actual management organization, there is a further need to realize new business paradigms by combining the system with a conventional management team, and to allow the system to participate in management as if it were an outside director. Conventional frameworks for corporate governance and board-level decision making do not adequately address the integration of an AI-based virtual member, and therefore do not fully exploit the possibility of enhancing creativity, tension, and independence in management deliberations. In view of the above circumstances, it is desired to provide a system capable of functioning as an AI-based management entity that cooperates with a conventional management team and acts as an outside director to support and transform management decision making.

### SUMMARY

In order to solve the above-described problems, according to one aspect of the present invention, there is provided a system comprising a processor, wherein the processor is configured to collect historical performance information, market trend information, and competitor information, and to convert the collected data into a format suitable for analysis. The processor is further configured to analyze the data using a machine learning algorithm to identify factors that affect a management strategy, and to generate an optimal management strategy by using a generative AI model based on the identified factors. By integrating data collection, data preprocessing, factor identification, and strategy generation in this manner, the system can autonomously produce management strategies that reflect complex interrelationships among performance indicators, market conditions, and competitive actions.

In addition, the processor is configured to obtain emotion information by using an emotion engine that recognizes a user's emotion, and to reflect the obtained emotion information in the generated management strategy. For example, the emotion engine may detect the user's emotional state such as anxiety, optimism, or risk aversion during interaction with the system, and the processor may adjust the aggressiveness, risk profile, or prioritization of strategic options according to the detected emotion. Thus, the system can generate strategies that are not only data-driven but also aligned with the psychological tendencies and preferences of the user or management team, thereby improving the acceptance and practicality of the strategies in actual corporate decision making.

Furthermore, the processor is configured to receive feedback from a user and to use the feedback to improve the generative AI model. In practical terms, the processor may log user evaluations of generated strategies, explicit corrections, and actual performance results after strategy execution, and may use these logs as training data to update or fine-tune the generative AI model and associated machine learning algorithms. Through this iterative improvement process, the system can progressively enhance the quality, relevance, and reliability of the management strategies it generates, adapting to environmental changes and organizational characteristics over time.

According to another aspect of the invention, the processor is configured to realize a new business paradigm by being combined with a conventional management team. In such a configuration, the system may operate as an AI-based member that continuously proposes strategies, risk assessments, and scenario analyses to the existing human management team, thereby enabling data-intensive and unbiased discussions that differ from traditional experience-based approaches. Moreover, the processor is configured to add enhanced originality and tension to a management team by actually participating in the management team as an outside director. In this role, the system can present independent opinions and voting recommendations based on its analytical and generative capabilities, thereby contributing to improved governance, diversified viewpoints, and more robust decision-making processes within the management team. Thus, the invention provides a comprehensive technical means to implement an AI-based system that generates, personalizes, and evolves management strategies, while operating in conjunction with, and as part of, an actual management body.

The term “historical performance information” refers to information representing past business results of an organization, including but not limited to sales, revenue, profit, cost, cash flow, balance-sheet items, and performance indicators over a predetermined period.

The term “market trend information” refers to information indicating past, current, or predicted changes in a market, including but not limited to market size, growth rate, demand fluctuation, price trends, and segment-specific trends.

The term “competitor information” refers to information related to other entities operating in the same or similar market as a subject organization, including but not limited to their market share, pricing, product or service offerings, strategic actions, and financial performance indicators.

The term “format suitable for analysis” refers to a data structure or representation in which collected data is cleaned, normalized, structured, or otherwise processed so that the data can be input into machine learning algorithms or other analytical processes.

The term “machine learning algorithm” refers to an algorithm or model that automatically learns patterns or relationships from training data and uses the learned patterns to perform tasks such as prediction, classification, clustering, or feature extraction without being explicitly programmed with task-specific rules.

The term “factors that affect a management strategy” refers to variables, indicators, or conditions, derived from data analysis, that have a significant impact on the formulation, selection, or evaluation of a management strategy, such as key performance indicators, market growth drivers, cost drivers, and competitive pressures.

The term “generative AI model” refers to an artificial intelligence model that generates new data or content, such as text, plans, or scenarios, based on learned patterns from existing data, and that is configured, in the context of the present invention, to generate management strategies using identified factors as input.

The term “optimal management strategy” refers to a management strategy generated by the system that satisfies one or more predetermined optimization criteria, such as maximizing expected profit, maximizing growth, minimizing risk, or achieving a specified balance among multiple objectives.

The term “emotion engine” refers to a software and/or hardware component that is configured to recognize or estimate a user's emotional state based on one or more inputs, including but not limited to voice, facial expression, physiological signals, textual input, or interaction patterns.

The term “emotion information” refers to information indicating a user's emotional state or tendencies, such as levels of anxiety, optimism, risk aversion, confidence, or satisfaction, which is obtained by the emotion engine and used by the system for strategy generation or adjustment.

The term “feedback from a user” refers to explicit or implicit responses provided by a user regarding the generated management strategy or the behavior of the system, including but not limited to evaluations, corrections, ratings, comments, acceptance or rejection decisions, and performance outcomes associated with implementation of a strategy.

The term “improve the generative AI model” refers to a process of updating, retraining, fine-tuning, or otherwise modifying the generative AI model using user feedback or additional data so as to enhance the accuracy, relevance, reliability, or usefulness of the management strategies generated by the model.

The term “conventional management team” refers to a group of human individuals, such as executives, directors, or managers, that is responsible for making management decisions in a traditional organizational structure without the system functioning as a management team member.

The term “new business paradigm” refers to a qualitatively different mode of conducting or governing business activities that arises from integrating the system with a conventional management team, such that decision-making processes, strategy formulation, or governance structures are transformed beyond conventional practice.

The term “outside director” refers to a member of a management team or board of directors who is not involved in day-to-day operations of the organization and is expected to provide independent oversight and opinions; in the context of the present invention, the term also encompasses a virtual or AI-based member that participates in management as if it were such an independent director.

The term “participating in the management team as an outside director” refers to the operation of the system in a role analogous to that of an outside director, in which the system provides independent opinions, analyses, recommendations, or voting indications in connection with management or board-level decisions.

The term “originality” refers to the degree to which the system introduces novel perspectives, unconventional strategic options, or creative solutions that differ from typical or historically observed approaches of the conventional management team.

The term “tension” refers to a constructive state of heightened scrutiny, critical discussion, or challenge within a management team, which is increased by the presence of independent opinions or divergent recommendations provided by the system acting as an outside director.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

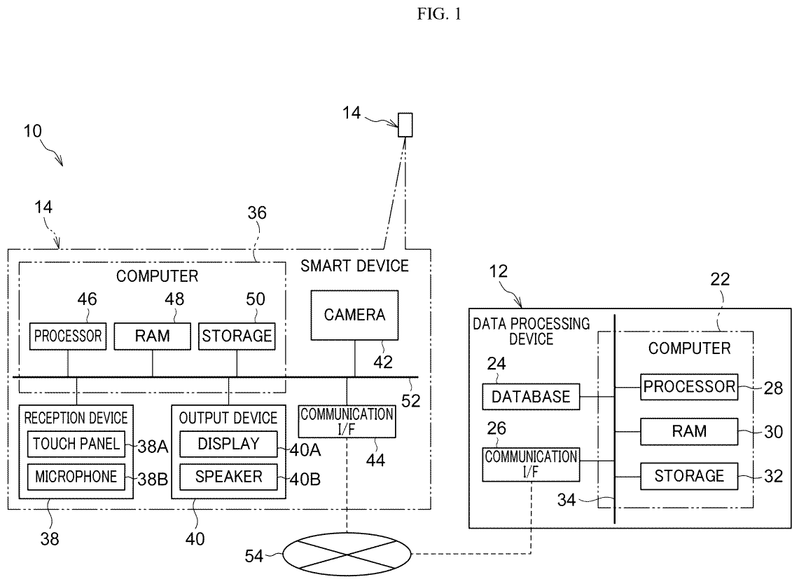

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

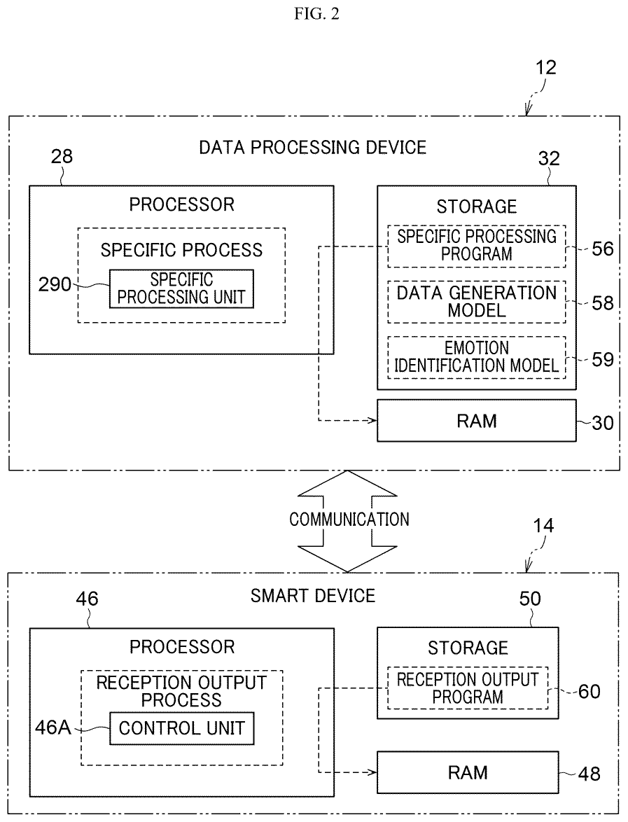

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented management support systems primarily focus on static reporting, simple statistical analysis, or rule-based recommendation, and therefore cannot effectively handle the scale, heterogeneity, and dynamism of modern enterprise data. In particular, there are several interrelated technical problems in the way conventional information processing architectures acquire, transform, and utilize data for strategy generation.

First, conventional systems lack an integrated, machine-oriented data pipeline that converts raw, heterogeneous data streams from internal data stores and external network resources into a unified numerical representation optimized for machine learning. As a result, processors frequently expend excessive computing resources on ad hoc data cleaning and manual feature engineering, leading to inefficient memory utilization, unstable model behavior, and limited automation in large-scale environments.

Second, although machine learning algorithms can identify patterns within numerical data, existing architectures do not systematically couple these analytical results with natural-language generative models in a way that is controllable, reproducible, and adaptive. In particular, the absence of a structured, automatically generated prompt sentence that encodes factor information, business objectives, constraint conditions, and output format causes generative models to produce inconsistent or non-compliant outputs. This leads to unpredictable runtime behavior, difficulty in enforcing operational constraints, and reduced reliability of automatically generated strategies.

Third, conventional systems rarely incorporate user feedback and user emotion information as first-class signals in the computational loop. Feedback, if collected at all, is often stored as unstructured text that is not fed back into the model control logic or training data in a systematic manner. Similarly, user emotion is not analyzed to adapt model outputs in real time. Consequently, the system cannot dynamically refine the behavior of the generative AI model or adjust prompt generation logic based on human evaluations or emotional states, which limits the ability of the computing system to converge toward user-aligned, context-aware strategy proposals.

Fourth, existing systems generally treat AI-generated strategies as stand-alone outputs rather than as components integrated into human organizational decision-making processes. There is no clear computational mechanism by which the processor coordinates continuous data-driven analysis with a human decision-making organization so as to provide persistent, objective inputs into governance workflows. This results in fragmented usage of AI-generated content and prevents the computing architecture from fully exploiting iterative cycles of data collection, model improvement, and human review.

Accordingly, there is a need for an improved information processing system and server architecture that (i) establishes a robust, automated data pipeline optimized for machine learning, (ii) programmatically constructs and manages prompt sentences for a generative AI model based on identified factors and constraints, (iii) incorporates user feedback and emotion analysis into the control and training of the generative AI model, and (iv) integrates the resulting management strategy proposals into human decision-making processes in a technically coherent manner. Such an architecture should enhance the stability, controllability, and adaptability of computer-implemented strategy generation, thereby improving the underlying computer technology itself rather than merely automating a human mental process.

The specific processing by the specific processing unit 290 of the data processing device 12 in Example 1 is realized by the following means.

The present invention provides a server comprising a processor and a memory storing instructions that, when executed by the processor, cause the processor to acquire heterogeneous business-related data including past performance information, market trend information, and competitor information from at least one storage apparatus and through at least one communication network interface, to store the acquired data in a tabular data structure, and to perform automated preprocessing including missing-value completion, outlier removal, normalization, and encoding to generate a numerical data set suitable for machine learning; to execute, on the numerical data set, at least one machine learning algorithm that constitutes a prediction model or a classification model, thereby performing numerical computation and parameter optimization to identify factors affecting at least one management indicator and to generate factor information; to automatically construct, based on the factor information and management objective information, a prompt sentence that includes at least a role definition, an analysis summary, constraint conditions, and an output format; to input the prompt sentence into a generative artificial intelligence model and to execute matrix operations on internal parameters of the generative artificial intelligence model so as to generate a text-based management strategy proposal; to transmit the management strategy proposal to a terminal device for display to a user, to receive feedback information including evaluation information and comment information from the terminal device, and to analyze the feedback information to update at least one of the constraint conditions and generation rules for the prompt sentence and to retrain or fine-tune the generative artificial intelligence model or a control parameter thereof using the feedback information as training data; and to execute emotion analysis processing on user interaction data so as to obtain emotion information regarding the user and to adjust at least one of content and expression format of the prompt sentence and the management strategy proposal according to the emotion information. This enables a computer-centered architecture in which a server implements an end-to-end, feedback-driven data processing and model control pipeline that (i) efficiently transforms heterogeneous business data into machine-optimized numerical representations, (ii) systematically constrains and conditions a generative AI model through automatically generated prompt sentences reflecting identified factors and operational constraints, (iii) continuously refines model behavior and prompt logic based on structured user feedback and emotion analysis, and (iv) provides stable, context-aware management strategy proposals that are technically integrated with human decision-making processes, thereby improving the technical performance, controllability, and adaptability of the underlying computer system.

The term “past performance information” refers to data representing historical results of an organization, including at least sales, revenue, profit, cost, and other quantitative or qualitative indicators recorded over one or more past periods.

The term “market trend information” refers to data representing temporal changes or predicted changes in a market, including at least market size, growth rate, price levels, demand patterns, and segment behavior for one or more products or services.

The term “competitor information” refers to data representing activities and conditions of entities that supply products or services in competition with an organization, including at least information regarding pricing, product offerings, promotions, advertising, and market share.

The term “external storage device” refers to any storage apparatus accessible to a server through a communication interface, including at least network-accessible storage, remote databases, and cloud-based storage services.

The term “communication network” refers to any wired or wireless communication infrastructure that enables data transmission between a server, a terminal device, and external data sources, including at least local area networks, wide area networks, and public data networks.

The term “data acquisition interface” refers to a software and hardware combination that enables a processor to acquire data from one or more external storage devices or networked data sources, including at least database interfaces and programmatic network interfaces.

The term “tabular data structure” refers to a data representation in which data elements are organized in rows and columns, such as a table or a matrix, where each column corresponds to an attribute and each row corresponds to a record.

The term “preprocessing” refers to a series of computational operations applied to raw data before machine learning, including at least completion of missing values, removal or adjustment of outliers, normalization or scaling of numerical values, and encoding of categorical values.

The term “missing-value completion” refers to a processing operation in which absent or undefined data elements are replaced with substitute values derived from statistics, rules, or models.

The term “outlier removal” refers to a processing operation in which data elements that deviate significantly from a normal range or distribution are removed, adjusted, or limited according to predetermined criteria.

The term “normalization” refers to a transformation applied to data values so that they fall within a specified range or distribution, such as scaling values to a standardized range or adjusting them to have a specified mean and variance.

The term “encoding” refers to a transformation that converts non-numerical data, such as categorical or textual information, into numerical representations suitable for numerical computation by machine learning algorithms.

The term “numerical data set suitable for machine learning” refers to a collection of data records represented as numerical vectors or matrices, organized so that each record can be directly processed by a machine learning algorithm without additional type conversion or structural modification.

The term “machine learning algorithm” refers to a computational procedure that uses data to adjust internal parameters of a model so as to approximate a mapping between input variables and output variables, including at least regression models, classification models, and neural networks.

The term “prediction model” refers to a machine learning model configured to output estimated future or unknown values of one or more variables based on input feature values representing known information.

The term “classification model” refers to a machine learning model configured to assign one or more category labels to an input instance based on learned decision boundaries in a feature space.

The term “information processing apparatus” refers to an electronic computing system comprising at least one processor and a memory, configured to execute software instructions to perform data processing operations.

The term “numerical computation processing” refers to operations performed by a processor on numerical data, including at least vector and matrix operations, arithmetic operations, and evaluation of mathematical functions.

The term “parameter optimization processing” refers to a computational procedure that adjusts model parameters, such as weights and biases, so as to minimize or maximize an objective function defined on training data.

The term “management indicator” refers to a quantitative or qualitative measure used to evaluate performance of an organization, including at least revenue, profit, margin, growth rate, market share, and customer-related metrics.

The term “factor information” refers to data representing one or more variables or conditions identified as having an impact on at least one management indicator, including information about feature importance or sensitivity.

The term “management objective information” refers to data representing at least one target state or goal for organizational performance, such as desired sales, profit, growth, or risk level within a specified period.

The term “prompt sentence” refers to a structured natural language text used as input to a generative artificial intelligence model, the text including at least a role instruction, a summary of analysis, constraint conditions, and a specification of desired output format.

The term “prompt generation unit” refers to a functional component implemented by software and hardware that constructs a prompt sentence based on factor information, management objective information, and predefined rules or templates.

The term “role definition” refers to a portion of a prompt sentence that instructs a generative artificial intelligence model to behave as if it were a particular type of agent, such as a consultant or analyst.

The term “analysis summary” refers to a portion of a prompt sentence that concisely describes key results or findings derived from data analysis or model output.

The term “constraint conditions” refers to limitations or rules specified in a prompt sentence that restrict allowable content, ranges, or structures in an output generated by a model.

The term “output format” refers to a specification in a prompt sentence that defines how generated content should be structured or presented, such as in paragraphs, bullet points, lists, or tables.

The term “generative artificial intelligence model” refers to a machine learning model configured to generate new data instances, including at least text sequences, conditioned on input data such as prompt sentences and internal learned parameters.

The term “management strategy proposal” refers to a structured set of recommendations generated by a generative artificial intelligence model, the recommendations including at least planned actions, priorities, and resource allocations directed toward achieving a management objective.

The term “matrix operation processing” refers to computational procedures involving matrices, including at least matrix multiplication, addition, and other linear algebra operations used within a model.

The term “internal parameters” refers to values maintained inside a machine learning model, such as weights, biases, and intermediate embeddings, that determine the model's behavior during inference.

The term “text generation processing” refers to an operation performed by a generative artificial intelligence model in which a sequence of tokens or symbols representing text is produced one or more tokens at a time based on previous context and internal parameters.

The term “terminal device” refers to an electronic device operated by a user and configured to communicate with a server, including at least personal computers, mobile devices, and tablet devices.

The term “display interface” refers to a hardware and software combination that presents information to a user visually on a terminal device, including at least graphical user interfaces and web-based interfaces.

The term “presentation unit” refers to a functional component implemented by software and hardware that transmits content from a server to a terminal device and controls how the content is presented to a user.

The term “feedback information” refers to data received from a user in response to presented content, including at least evaluation information, comment information, and modification requests relating to a generated management strategy proposal.

The term “evaluation information” refers to data that expresses a user's assessment of the quality, usefulness, or feasibility of generated content, such as scores, ratings, or categorical judgments.

The term “comment information” refers to user-provided textual or symbolic annotations that describe opinions, corrections, or additional conditions related to generated content.

The term “model improvement unit” refers to a functional component implemented by software and hardware that processes feedback information and modifies at least one of model parameters, control parameters, or prompt generation rules so as to improve model behavior.

The term “training data” refers to data used to adjust parameters of a model, including at least pairs of inputs and desired outputs, or inputs together with associated evaluation signals.

The term “control parameter” refers to a parameter that influences how a model is used or how output is generated, including at least temperature settings, sampling strategies, and configuration options for content filtering.

The term “retraining” refers to a process in which a model is trained using additional or updated training data, starting from an initial state or previously learned state.

The term “fine-tuning” refers to a process in which a model that has been previously trained on generic data is further trained on specialized data to adapt its behavior to a specific domain or task.

The term “user interaction data” refers to data representing how a user interacts with a system, including at least input actions, navigation behavior, and response timing during interaction with presented content.

The term “emotion information” refers to data representing an estimated emotional state of a user, such as satisfaction, frustration, interest, or confusion, derived from user interaction data or other signals.

The term “emotion acquisition unit” refers to a functional component implemented by software and hardware that performs emotion analysis processing on user interaction data to obtain emotion information.

The term “emotion reflection unit” refers to a functional component implemented by software and hardware that adjusts at least one of prompt generation and management strategy proposal generation according to emotion information.

The term “output content” refers to the substantive information contained in generated text, including specific recommendations, rationales, and descriptive elements of a management strategy proposal.

The term “expression format” refers to the style or structural arrangement in which output content is presented, including at least tone, level of detail, ordering of sections, and use of headings or bullet points.

The term “human management decision-making organization” refers to a group of human agents responsible for making management decisions for an entity, including at least executive bodies, boards, and committees.

The term “decision-making body involved in corporate governance” refers to a formal organizational unit charged with oversight and decision-making responsibilities relating to governance, including at least boards of directors, committees, and similar governance structures.

The term “resolution document” refers to a document or data structure used as a basis for discussion and decision within a decision-making body, including at least agendas, proposals, and supporting explanatory materials.

In one embodiment, a server, a terminal, and a user cooperate to implement the present invention. The server includes at least one processor, a memory, a non-volatile storage apparatus, and at least one network interface controller. The terminal includes at least one processor, a memory, a display device, an input device, and a network interface. The user operates the terminal to view management strategy proposals and to provide feedback. The server executes a program stored in the memory to implement functional units corresponding to the data acquisition interface, the data formatting unit, the factor identification unit, the prompt generation unit, the management strategy generation unit, the presentation unit, the model improvement unit, the emotion acquisition unit, and the emotion reflection unit.

The server uses general-purpose computer hardware such as a multi-core central processing unit and, optionally, one or more graphics processing units. The server uses software components including an operating system, a database management system, a numerical computation library, a machine learning framework, and a data analysis library. In one example, the server uses a relational database management system such as a generic SQL database, a data analysis library such as a generic DataFrame library, and a machine learning framework such as a generic deep learning framework that supports tensor operations and automatic differentiation.

The server acquires past performance information, market trend information, and competitor information from at least one internal data store and at least one external data source. The server uses the data acquisition interface to send structured queries to the internal data store via a database driver and to send HTTP or other protocol requests to external data sources via the network interface controller. The server receives responses as structured data, for example in table form or as hierarchical key-value structures, and converts them into a unified tabular data structure stored in the memory.

The server uses the data formatting unit to perform preprocessing on the unified tabular data structure. The server uses a data analysis library such as a DataFrame library to implement missing-value completion, outlier removal, normalization, and encoding. The server computes statistical values such as mean, median, variance, and quantiles over each column in the tabular data structure. The server replaces missing entries with substitute values according to predetermined rules, for example by using the median value within a group of records having the same region and product category. The server detects outliers using a numerical criterion such as a z-score threshold or interquartile range and removes or caps the corresponding values. The server normalizes numerical features by scaling them to a standardized range or distribution, such as zero mean and unit variance, to improve numerical stability during subsequent machine learning. The server encodes categorical features, such as region identifiers and product categories, into numerical vectors, for example one-hot vectors, to create a numerical data set suitable for processing by the machine learning framework.

The server uses the factor identification unit to execute a machine learning algorithm implemented by the machine learning framework. In one embodiment, the server constructs a supervised learning model such as a feed-forward neural network. The server defines an input layer whose dimensionality matches the number of features in the numerical data set, one or more hidden layers comprising fully connected units with non-linear activation functions such as rectified linear units, and an output layer that outputs one or more target values, such as predicted future sales or profitability. The server defines a loss function such as mean squared error for regression or cross-entropy for classification. The server uses an optimization algorithm such as stochastic gradient descent with momentum or an adaptive learning rate method to update the model parameters.

The server trains the prediction model or classification model by iteratively performing forward propagation and backpropagation over batches of the numerical data set. During forward propagation, the server performs matrix multiplications between weight matrices and input vectors, adds bias vectors, and applies non-linear activation functions. During backpropagation, the server computes gradients of the loss function with respect to the model parameters using automatic differentiation capabilities of the machine learning framework and updates the parameters according to the optimization algorithm. The server optionally uses data augmentation techniques for time-series data, such as random temporal subsampling or noise injection, to improve generalization.

The server computes feature importance scores or similar factor metrics by using methods such as permutation importance, gradient-based saliency, or Shapley value approximations. The server thereby identifies which input features, such as competitor discount rate, regional advertising expenditure, or market growth rate, exert the greatest influence on the target management indicators. The server generates factor information as structured data containing ranked lists of features, associated importance scores, and qualitative tags describing the direction of influence.

The server uses the prompt generation unit to construct a prompt sentence based on the factor information and management objective information. The server maintains prompt templates stored in the memory. Each template includes slots for a role definition, an analysis summary, constraint conditions, and an output format specification. The server fills these slots by inserting specific factor information and objectives retrieved from configuration data. For example, the server generates a prompt sentence of the following form:

“You are a management strategy consultant. Based on the following analysis, propose a detailed strategy to maximize sales in the next quarter while keeping discounts at or below 15%. Analysis: (1) Region A has 12% quarterly market growth, but our market share fell by 3 points in the last two quarters. (2) Competitors in Region A offer 10-15% discounts and invest heavily in social media advertising. (3) Our digital advertising spend in Region A is 30% below the market average. Please propose a three-month action plan by region and by channel, including specific discount levels, advertising channels, and expected impact on sales.”

In another example, the server generates a simpler prompt sentence:

“Please propose a strategy to maximize sales in the next quarter under the following conditions: (1) Market demand for our main product is increasing by 10%. (2) Competitors are increasing their online advertising spending by 20%. (3) Discounts must not exceed 15%. Provide detailed actions by channel and region.”

The server uses the management strategy generation unit to interact with a generative AI model. In one embodiment, the generative AI model is a transformer-based neural network language model deployed either on the same server or on a separate computing apparatus accessible through the communication network. The generative AI model includes multiple layers of self-attention and feed-forward sub-layers, with each layer performing matrix multiplications between token embeddings and learned weight matrices, followed by non-linear activation functions and normalization operations.

The server encodes the prompt sentence into a sequence of token identifiers using a tokenizer associated with the generative AI model. The server then inputs the token sequence into the generative AI model. The generative AI model performs forward propagation, computing context-aware hidden representations for each token by applying self-attention mechanisms, where attention weights are computed as scaled dot products between query, key, and value vectors. The model then outputs a sequence of probability distributions over the vocabulary for the next token. The server selects tokens according to a sampling strategy, such as top-k sampling or nucleus sampling with a specified temperature parameter, to generate text that constitutes the management strategy proposal.

The server optionally constrains the decoding process by applying post-processing rules that enforce constraint conditions encoded in the prompt sentence. For example, the server may scan generated tokens for numeric discount values and reject candidate tokens that would produce values outside an allowed range. This non-conventional integration of symbolic constraint checking with neural text generation contributes to improved compliance with operational limits.

The server uses the presentation unit to transmit the generated management strategy proposal to the terminal. The server sends the proposal as structured data over the communication network, for example in a format that separates sections such as “Pricing Strategy,” “Marketing Strategy,” and “Operational Actions.” The terminal receives the proposal, renders it on the display device using a graphical user interface, and allows the user to scroll, expand sections, and highlight specific items.

The user uses the terminal to review the proposal. The user reads the proposed actions, such as regional discount levels, advertising channel allocations, and inventory adjustments. The user enters feedback by typing comments, selecting ratings, or marking elements as acceptable or unacceptable. The terminal packages the feedback as structured data and sends it back to the server.

The server uses the model improvement unit to process the feedback information. The server stores the feedback information, associated prompt sentence, and generated proposal in the database. The server executes natural language processing algorithms to classify feedback types, such as “excessive discounting,” “insufficient risk analysis,” or “non-feasible resource allocation.” The server extracts constraint patterns, for example that discounts in a particular region should not exceed a specified percentage, and updates the constraint conditions used by the prompt generation unit. This update may consist of adding new rules to a rule set, modifying upper or lower bounds for numeric values, or inserting mandatory disclaimers into the prompt templates.

The server optionally fine-tunes the generative AI model using the feedback as training data. The server forms pairs of prompt sentences and corresponding preferred outputs, where preferred outputs are either positively rated proposals or edited versions created by the user. The server uses a loss function that compares the model output to the preferred output, such as a token-level cross-entropy loss, and performs gradient-based optimization to adjust the model parameters. In another embodiment, the server uses reinforcement learning from human feedback, where the user's ratings are converted into reward signals and a policy optimization algorithm adjusts the generative model's behavior.

The server uses the emotion acquisition unit to estimate the user's emotion state. The server receives user interaction data from the terminal, such as time taken to read sections, frequency of scrolling, intensity of corrections, and patterns of cursor movement. The server may also receive explicit signals such as selection of emotion icons or simple ratings. The server applies statistical and machine learning methods, such as a classifier trained to map interaction patterns to emotional categories, to generate emotion information indicating states such as satisfaction, confusion, or frustration.

The server uses the emotion reflection unit to modify at least one of the prompt generation and the presentation of the management strategy proposal according to the emotion information. For example, when the user's emotion information indicates confusion, the server adjusts the prompt sentence to request more explanatory content and step-by-step rationale, by adding language such as “Explain the reasoning behind each recommendation in simple terms.” When the emotion information indicates that the user is satisfied but prefers concise output, the server modifies the output format specification in the prompt sentence to request a shorter answer, for example by adding “Summarize the strategy in no more than five bullet points.”

The server thereby implements non-conventional control over the generative AI model using both feedback information and emotion information. The server does not merely automate human guideline writing; instead, the server continuously adapts the numerical data processing pipeline, the prompt construction logic, and the model parameter space according to machine-detectable signals. This technical configuration leads to several computer-technical improvements.

First, the server reduces computational waste and improves training stability by normalizing and encoding heterogeneous data into a numerical data set optimized for tensor-based computation. This improves memory locality and reduces numerical overflow or underflow in deep learning frameworks, thereby increasing model training speed and accuracy.

Second, the server improves output reliability of the generative AI model by generating prompt sentences that explicitly encode factor information and machine-interpretable constraints. This structured prompt generation reduces the need for repeated user iterations and thereby reduces network traffic and computational load associated with multiple calls to the generative AI model.

Third, the server enhances model alignment with user preferences and organizational policies by incorporating feedback information and emotion information into the control loop. The server adjusts both symbolic rules (prompt templates and constraint conditions) and numerical parameters (model weights) according to structured feedback, resulting in lower error rates in subsequent proposals and improved convergence of the inference behavior.

Fourth, the server improves data management by storing and linking prompts, model outputs, feedback, and emotion information in a structured manner. This linkage enables efficient retrieval of past scenarios, facilitates batch model improvement operations, and reduces redundant computations because the server can reuse known good strategies when new data are similar to prior cases.

The terminal supports these effects by executing a dedicated client application or web application that renders content and captures user interactions with minimal latency. The terminal buffers user interaction data locally and transmits compressed summaries to the server, which reduces communication load while preserving sufficient detail for emotion analysis and feedback processing.

The user interacts with the system not by manually preparing data or writing extensive strategy documents, but by supplying judgments and preferences at a higher level. The server converts these judgments into structured signals that modify the internal workings of the data pipeline and the generative AI model, which is a form of computer-centric optimization beyond simple task automation.

In alternative embodiments, the server may use different types of machine learning models in the factor identification unit, such as gradient boosting decision trees, linear models with regularization, or recurrent neural networks for temporal sequences. The server may also use different architectures for the generative AI model, such as decoder-only transformer models or encoder-decoder architectures. The server may vary the loss functions, for example using Huber loss for robust regression or label smoothing for classification tasks. The server may implement different sampling schemes for text generation, such as beam search with constraints to enforce inclusion of mandatory elements.

In some embodiments, the server executes the generative AI model on dedicated accelerator hardware, and dynamically selects batch sizes and sequence lengths based on the available hardware resources and response time constraints. This adaptive resource control further improves throughput and reduces latency when generating management strategy proposals. In yet another embodiment, the server aggregates feedback from multiple users within an organization and computes aggregated preference models. The server then uses these models to shape prompts and control parameters differently for distinct user groups, thereby improving perceived quality without modifying the underlying model architecture. Through these embodiments, the server, the terminal, and the user collectively implement a concrete technical system in which heterogeneous data are transformed into machine-efficient representations, processed by specific machine learning algorithms and generative AI architectures, and iteratively refined based on structured feedback and emotion analysis. This configuration improves the technical functioning of the computer system, including processing speed, accuracy of generated content under constraints, data management efficiency, and communication load, beyond what can be achieved by manual or purely rule-based systems.

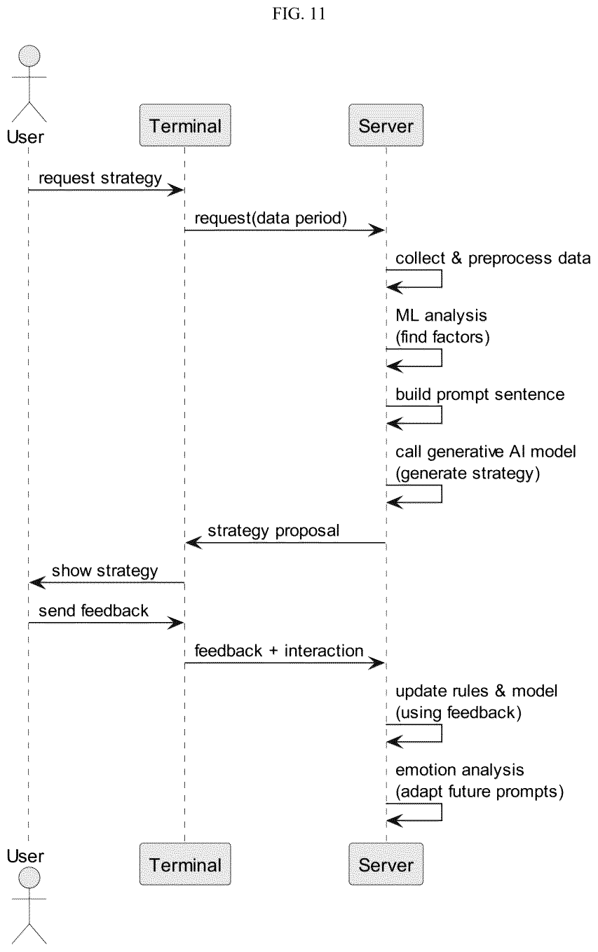

The following describes the processing flow using FIG. 11.

### Step 1:

The server acquires raw business data from internal and external sources.

The server receives, as input, requests or scheduled triggers indicating a new analysis period (for example, a specific quarter or month). Based on this input, the server sends structured queries to at least one internal database to obtain past performance information, and sends network requests to at least one external data source to obtain market trend information and competitor information.

The server processes the responses by parsing tabular or hierarchical data structures, and stores the parsed data into an in-memory tabular data structure in the server's memory. As output, the server generates a unified raw data table that combines internal records (for example, sales, costs, and profits by product and region) with external indicators (for example, market growth rates and competitor discount levels).

### Step 2:

The server preprocesses and formats the unified raw data table into a numerical data set.

The server receives, as input, the unified raw data table generated in Step 1. The server uses a data analysis library to compute descriptive statistics for each column, detect missing values, and identify outliers. Based on these statistics, the server performs missing-value completion by filling null entries with substitute values such as group-wise medians or means.

The server then detects outliers using a defined rule, such as values lying beyond a specified multiple of the interquartile range or a specified z-score threshold, and removes or caps such values. The server normalizes numerical columns, for example by scaling them to have a mean of zero and a standard deviation of one, and encodes categorical columns (such as region or product category) into numerical representations such as one-hot vectors.

As output, the server produces a cleaned and fully numerical data set in a matrix-like structure, where each row corresponds to a sample and each column corresponds to a machine-readable feature ready for machine learning.

### Step 3:

The server identifies influential factors using a machine learning model.

The server receives, as input, the cleaned numerical data set from Step 2 and configuration parameters specifying target variables (for example, next-period sales) and model type (for example, regression or classification). The server constructs a prediction or classification model, such as a feed-forward neural network with an input layer matching the feature dimension, one or more hidden layers with non-linear activations, and an output layer representing the target management indicator.

The server splits the numerical data set into training and validation subsets according to a predetermined ratio. The server performs repeated training iterations in which it feeds batches of input data through the model to compute predictions (forward propagation), calculates a loss value (for example, mean squared error), and performs backpropagation using an optimization algorithm to update model parameters.

After training, the server applies feature importance analysis methods, such as permutation importance or gradient-based saliency, to measure the impact of each feature on the model's output. As output, the server generates factor information that includes a ranked list of features (for example, competitor discount rate, regional advertising expenditure) and associated importance scores indicating how strongly each feature affects the management indicator.

### Step 4:

The server generates a prompt sentence for the generative AI model.

The server receives, as input, the factor information from Step 3, management objective information (for example, a goal to maximize sales under certain constraints), and stored prompt templates. The server selects an appropriate template and fills template slots with the specific factor information and objectives.

The server composes a role definition (for example, instructing the model to act as a management strategy consultant), an analysis summary describing key patterns (for example, regions with high growth but declining market share), explicit constraint conditions (for example, maximum discount percentages), and an output format specification (for example, bullet points grouped by region and channel).

The server concatenates these elements into a single natural language prompt sentence. As output, the server produces a fully constructed prompt sentence that encodes both analytical insights and operational constraints in a structured textual form suitable for input to the generative AI model.

### Step 5:

The server generates a management strategy proposal using the generative AI model.

The server receives, as input, the prompt sentence produced in Step 4. The server tokenizes the prompt sentence into a sequence of token identifiers using a tokenizer associated with the generative AI model. The server feeds the token sequence into a transformer-based generative AI model that performs multiple layers of matrix multiplications and self-attention operations to compute contextual representations for each token.

The generative AI model outputs, at each decoding step, probability distributions over possible next tokens. The server selects specific tokens using a defined sampling strategy, such as top-k or nucleus sampling with a specified temperature value, thereby generating a coherent text continuation that describes a management strategy. The server optionally applies constraint checks during decoding, for example rejecting candidate tokens that would lead to discount values exceeding allowed thresholds.

As output, the server obtains a structured natural language management strategy proposal, which may be organized into sections such as pricing, marketing, and operations, and which is associated with metadata such as time of generation and model version.

### Step 6:

The server transmits the management strategy proposal to the terminal, and the terminal displays it to the user.

The server receives, as input, an internal representation of the management strategy proposal from Step 5. The server packages the proposal into a structured response, for example by separating it into labeled sections and including identifiers for traceability, and sends this response over a communication network to the terminal.

The terminal receives the structured response as input. The terminal parses the response and maps each section to corresponding user interface components. The terminal renders the text of the management strategy proposal on the display device, showing headings, bullet points, and any associated indicators such as projected performance values. As output, the terminal presents a visual representation of the management strategy proposal that the user can read, scroll, and inspect.

### Step 7:

The user reviews the management strategy proposal and provides feedback.

The user receives, as input, the visual representation of the management strategy proposal displayed on the terminal. The user reads the recommendations, compares them against internal constraints or preferences, and decides which parts are acceptable or require modification.

The user operates the input device of the terminal to enter feedback, such as free-form comments, numerical ratings, or selections indicating acceptance or rejection of specific recommendations. The user may, for example, type that a suggested discount level is too high for a given region or that additional risk analysis is needed, and may assign an overall feasibility score.

As output, the user generates feedback information that expresses their evaluation and preferences regarding the generated strategy.

### Step 8:

The terminal sends user feedback and interaction data to the server.

The terminal receives, as input, the feedback information entered by the user in Step 7 and, optionally, user interaction data such as timestamps, scrolling behavior, and selection patterns. The terminal aggregates this information into a structured payload, associating it with identifiers for the corresponding prompt sentence and strategy proposal.

The terminal compresses or encodes the payload as needed to reduce transmission size and sends it to the server over the communication network. As output, the terminal provides the server with a structured representation of user feedback and interaction data.

### Step 9:

The server processes feedback to update prompt generation rules and model behavior.

The server receives, as input, the feedback information and interaction data transmitted by the terminal in Step 8, along with stored records of the original prompt sentence and generated strategy. The server uses natural language processing techniques to parse the comment information, classify feedback into categories (for example, “excessive discounting” or “insufficient detail”), and extract refined constraints (for example, new maximum discount levels per region).

The server updates internal rule sets used by the prompt generation unit, for example by changing numeric bounds or adding explicit instructions such as “do not propose discounts exceeding 5% in a specified region.” The server also compiles a training data set from pairs of prompt sentences and positively rated or user-edited strategy texts. The server uses this training data to perform retraining or fine-tuning of the generative AI model, adjusting its internal parameters by running additional optimization steps with a defined loss function that encourages alignment with preferred outputs.

As output, the server produces updated prompt generation rules and an updated generative AI model configuration that are better aligned with user preferences and organizational policies.

### Step 10:

The server estimates user emotion and adjusts future outputs accordingly.

The server receives, as input, user interaction data from Step 8 and, optionally, explicit emotion-related signals if provided by the user. The server uses an emotion acquisition unit that applies statistical analysis or a trained classifier model to map interaction patterns, such as prolonged dwell times on certain sections or frequent edits, to emotion categories like confusion, dissatisfaction, or satisfaction.

The server generates emotion information summarizing the user's likely emotional state. The server then uses this emotion information to modify future prompt sentences and output formatting; for example, the server may adjust templates to request more detailed explanations when confusion is detected, or more concise summaries when satisfaction but time pressure is inferred.

As output, the server updates internal configuration parameters for the prompt generation unit and the presentation unit so that subsequent prompt sentences and strategy proposals are adapted to the user's emotional context, thereby improving clarity, usability, and effectiveness of the system's future outputs.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented management support systems for electronic commerce environments typically focus on isolated analytical functions such as demand forecasting, inventory tracking, or price optimization. These systems often employ generic machine learning models that operate on pre-processed data, but they do not provide an integrated, end-to-end computational framework that: (i) systematically transforms heterogeneous operational and market data into machine-consumable structures, (ii) couples predictive models with optimization logic under explicit constraints, and (iii) translates numerical strategy outputs into adaptive natural-language management plans. As a result, several technical problems arise within the computing infrastructure itself.

First, existing systems require substantial manual intervention to clean, normalize, and structure raw enterprise data from multiple sources. The lack of an automated and unified data processing pipeline increases computational overhead, introduces latency, and makes it difficult for the processor to consistently supply prediction models with high-quality, feature-rich input. This leads to suboptimal utilization of processing resources and degraded prediction accuracy.

Second, conventional prediction engines generally treat demand forecasting, inventory calculation, and price optimization as separate modules, without a cohesive representation of objective functions and constraints. Consequently, the processor cannot efficiently compute globally consistent strategy candidates that reflect capacity limits, margin thresholds, and promotion budgets in a mathematically coherent manner. This fragmentation results in repeated data transfers between components, redundant computations, and an inability to systematically refine strategies in response to updated constraints, thereby causing inefficiencies in the use of memory, storage, and processing cycles.

Third, traditional systems do not tightly integrate generative AI models and prompt sentence generation into the core computational loop. Typically, any natural-language output, if present at all, is produced by static templates or manually crafted reports. Without an automated mechanism that converts numerical prediction and optimization results into context-aware prompts for a generative model, the processor cannot effectively leverage generative AI capabilities. This leads to a technical limitation: the computing platform fails to exploit an available model to automatically generate detailed, user-adaptive management strategies, and the system remains heavily dependent on manual interpretation and report drafting.

Fourth, existing systems rarely incorporate user feedback and constraint updates into a closed-loop retraining and refinement framework. Feedback data, if collected, are often stored as unstructured logs that are not systematically integrated into model retraining or strategy recalculation. This lack of a feedback-driven learning loop prevents the processor from dynamically improving the prediction model and the generative model in response to real-world outcomes and user evaluations, keeping the system static and limiting its capability to adapt to changing data distributions and business conditions.

Accordingly, there is a need for a computer-implemented system that improves the functioning of the processor and its associated components by: (i) automatically generating structured analysis information from heterogeneous historical and external environment data; (ii) constructing and using prediction models to compute detailed forecast indicators; (iii) formulating and solving strategy candidate calculations under explicit objective functions and constraints; (iv) generating prompt sentences and natural-language management strategy proposals using a generative AI model in a programmatically controlled manner; and (v) incorporating user-specific constraints and feedback to iteratively refine both the numerical strategy computation and the natural-language generation. Such a system would improve the overall computational pipeline, reduce manual processing, and enhance the technical performance and adaptability of the underlying computing environment.

The specific processing by the specific processing unit 290 of the data processing device 12 in Application Example 1 is realized by the following means.

The present invention provides a server comprising a processor configured to acquire, from a storage infrastructure, heterogeneous historical information and external environment information, to convert the acquired information into structured tabular analysis information, to execute, by means of a data processing program, an automated preprocessing pipeline including missing-value handling, outlier handling, aggregation, time-series transformation, and encoding in order to generate feature information related to demand, inventory, price, and sales promotion, to construct, by means of a learning program, a prediction model that uses the feature information as input and to generate, with the prediction model, prediction information including future demand indicators, sales indicators, inventory indicators, and price elasticity indicators, to formulate, on the basis of the prediction information and the feature information, an objective function and constraint conditions relating to inventory levels, price levels, and sales promotion measures and to compute, by executing a strategy candidate calculation, numerical strategy candidates including replenishment quantities, candidate sales prices, and candidate promotion measures, to generate, by means of a generative information processing model having a natural language generation function, natural-language management strategy proposals by inputting numerical and structured information corresponding to the strategy candidates into the generative information processing model, to automatically generate a prompt sentence to be input to the generative information processing model in accordance with the prediction information and output information of the strategy candidate calculation, to embed condition information relating to the inventory levels, the price levels, and the sales promotion measures into the prompt sentence, to receive constraint condition information and priority information from a user terminal, to reflect the received constraint condition information and priority information in the objective function and the constraint conditions and re-execute the strategy candidate calculation so as to update the prompt sentence and the management strategy proposals, and to acquire evaluation information and feedback information from the user terminal and use the evaluation information and the feedback information for retraining the prediction model and the generative information processing model so as to continuously improve accuracy of the prediction information and accuracy of the management strategy proposals. This enables an improved computer-implemented management support pipeline in which the processor automatically transforms raw enterprise and market data into optimized, constraint-aware strategy candidates and corresponding natural-language plans, reduces manual intervention and redundant computations, and enhances adaptability and technical performance of the system through closed-loop refinement using user constraints and feedback.

The term “historical information” refers to information representing past states or events of an enterprise or system, including but not limited to performance records, transaction logs, and demand records accumulated over time.

The term “external environment information” refers to information representing conditions outside an enterprise or system that may influence operations, including but not limited to market trend information, competitor situation information, and macroeconomic indicators.

The term “storage device” refers to a hardware component or subsystem configured to store digital information, including but not limited to non-volatile memory, magnetic storage, optical storage, and any combination thereof.

The term “information management infrastructure” refers to a logical or physical arrangement of software components, databases, and interfaces configured to manage, organize, and provide access to stored information.

The term “structured tabular analysis information” refers to information that has been organized into a tabular format, such as rows and columns, with defined fields and data types, so that it can be directly processed by analytical or machine learning algorithms.

The term “data processing program” refers to software configured to manipulate, transform, and analyze data, including but not limited to programs providing statistical processing, data cleaning, aggregation, and feature generation functions.

The term “missing-value processing” refers to a procedure for handling data entries in which values are absent, including but not limited to imputing values, flagging missing entries, or removing incomplete records.

The term “outlier processing” refers to a procedure for identifying and handling data points that deviate significantly from expected ranges or distributions, including but not limited to capping, transforming, or excluding such data points.

The term “aggregation processing” refers to a procedure in which multiple data records are combined according to one or more keys or grouping criteria to generate summarized values such as totals, averages, or counts.

The term “time-series processing” refers to a procedure for transforming and analyzing data that are indexed or ordered in time, including but not limited to computing rolling statistics, temporal features, and lagged variables.

The term “encoding processing” refers to a procedure for converting data values, including categorical or textual values, into numerical or structured representations that can be processed by machine learning algorithms.

The term “feature information” refers to derived or transformed data elements used as inputs to a prediction model, the data elements representing characteristics of demand, inventory, price, sales promotion, or other relevant aspects.

The term “learning program” refers to software implementing machine learning or statistical learning algorithms configured to construct, train, and update prediction models based on input data.

The term “prediction model” refers to a computational model, obtained by training with data, that is configured to generate prediction information such as future demand, sales indicators, inventory indicators, or price elasticity indicators.

The term “prediction information” refers to output values generated by a prediction model that estimate or forecast future states or performance metrics of items, services, or systems.

The term “objective function” refers to a mathematical expression or criterion that quantifies a performance measure, such as revenue, profit, or cost, which is to be optimized by a computational process.

The term “constraint conditions” refers to mathematical or logical conditions that restrict the feasible range of variables in an optimization or decision-making process, including but not limited to capacity limits, budget limits, and margin thresholds.

The term “strategy candidates” refers to sets of calculated values representing possible courses of action, including but not limited to replenishment quantities, candidate sales prices, and candidate promotion measures.

The term “replenishment quantities” refers to calculated amounts of items to be procured, manufactured, or transferred so as to achieve desired inventory levels in a future time period.

The term “candidate sales prices” refers to one or more proposed price values for items or services that are evaluated or selected in an optimization process.

The term “candidate promotion measures” refers to proposed actions designed to stimulate demand or sales, including but not limited to discounts, campaigns, and targeted offers.

The term “generative information processing model” refers to a computational model configured to generate new data, including natural-language text, based on input information, and including but not limited to generative AI models such as large language models.

The term “natural language generation function” refers to a capability of a model or program to produce human-readable text in one or more natural languages based on structured or unstructured input data.

The term “management strategy proposals” refers to natural-language descriptions of recommended management actions or policies, including inventory management policies, pricing policies, and sales promotion policies.

The term “electronic transaction platform” refers to a network-based system configured to facilitate the buying and selling of goods or services via electronic communication.

The term “prompt sentence” refers to a natural-language or structured textual input provided to a generative information processing model, the input specifying context, constraints, or instructions for generating a corresponding output.

The term “condition information” refers to information representing constraints, targets, or situational parameters, including but not limited to inventory levels, price levels, and sales promotion measures, that are embedded into a prompt sentence or used in optimization.

The term “user terminal” refers to an information processing device operated by a user, including but not limited to a personal computer, a mobile terminal, or any other communication-enabled device.

The term “constraint condition information” refers to information provided by a user that specifies limits or requirements, such as capacity limits, minimum margins, or budget limits, for use in optimization or decision-making processes.

The term “priority information” refers to information indicating relative importance or ranking of objectives, items, or constraints, used to influence optimization or decision-making processes.

The term “evaluation information” refers to information indicating a user's assessment of generated predictions, strategies, or outputs, including ratings, approvals, or qualitative comments.

The term “feedback information” refers to information representing outcomes, user reactions, or corrections related to generated predictions or strategies, used to improve or adjust models or processes.

The term “retraining” refers to a process of updating parameters of a prediction model or generative information processing model using new data, evaluation information, or feedback information to improve performance.

The term “processor” refers to one or more hardware processing units, such as central processing units or graphics processing units, configured to execute instructions and perform the operations described for the system.

In one embodiment, a server implements the claimed system as an integrated management support platform for an electronic transaction environment. The server is realized on a computer system including at least one processor, a main memory, a non-volatile storage device, and a network interface. The server operates under an operating system such as a general-purpose server operating system and executes application software implemented using a programming language such as Python or another high-level language. The server uses a database management system, such as a relational database, as a storage device to store historical information and external environment information. The server stores transactional records (e.g., order tables, item tables, customer tables), performance logs (e.g., revenue and margin tables), and demand-related logs (e.g., daily quantity per item) in normalized relational schemas. The server also stores external environment information, such as market index time-series tables and competitor price time-series tables. The server accesses these tables using a database driver and retrieves data into the main memory. The server uses a data processing library, such as a tabular data analysis library equivalent to Pandas, to represent the retrieved information as in-memory data frames. Each data frame is a two-dimensional table with named columns (e.g., item identifier, transaction timestamp, quantity, unit price, customer segment, market index). The server converts date and time strings into machine-parseable timestamp data types and standardizes categorical fields into coded integer or one-hot encoded vectors using an encoding function provided by a machine learning library equivalent to Scikit-learn.

The server executes missing-value processing by scanning each column of the data frame to detect absent entries and applies preconfigured imputation rules. For numeric fields, the server may compute a median or mean for the corresponding item group and overwrite missing values with this representative statistic. For categorical fields, the server may insert a dedicated “unknown” category code. By performing this processing within contiguous memory buffers used by the data frame, the server reduces cache misses and improves memory locality compared to ad hoc row-wise operations.

The server executes outlier processing by computing statistical measures such as z-scores or interquartile ranges for quantity and price columns. The server flags records whose values exceed a predetermined threshold and either clips those values to an upper bound or removes the flagged rows. This pre-processing stabilizes the input distribution to downstream machine learning models and reduces numerical instability during gradient-based optimization, thus improving convergence speed and prediction accuracy.

The server performs aggregation processing by grouping the data frame by keys such as item identifier and time period (e.g., day, week, month) and then computing aggregated metrics including total quantity, average price, total revenue, and count of transactions. The server uses vectorized group-by operations provided by the tabular library, which are implemented to scan contiguous segments of memory and use optimized hash or sort-based grouping algorithms. This allows the server to compute tens of millions of aggregates efficiently without explicit loops, directly improving throughput for large-scale historical datasets.

The server performs time-series processing by constructing additional feature columns, such as lag features (e.g., sales in the previous 7 days and 30 days), rolling means, and rolling standard deviations. The server computes these features using time-indexed windows on the aggregated tables. This time-series enrichment enables the prediction model to capture temporal dependencies that would be difficult to represent with simple static features.

The server constructs feature information by combining aggregated, time-series, and encoded features into a single, high-dimensional data structure. The server aligns feature vectors by item identifier and forecast horizon and ensures that the resulting feature matrix is stored in a column-major or row-major format compatible with the input tensors required by a training framework such as TensorFlow. By explicitly aligning and compressing features before model training, the server minimizes unnecessary conversion overhead and reduces memory footprint.

In one embodiment, the server constructs a prediction model as a neural network implemented using a deep learning framework such as TensorFlow with a high-level API equivalent to Keras. The server defines an input layer whose dimension corresponds to the number of engineered features. The server configures one or more hidden layers, such as fully connected layers with rectified linear unit activation functions and optional batch normalization layers, to stabilize training. In a time-series variant, the server uses recurrent layers, such as long short-term memory (LSTM) layers, to model sequential dependencies in historical sales per item.

The server trains the prediction model using supervised learning. The server sets an objective function such as mean squared error or mean absolute error between the predicted demand and the actual observed demand in the training data. The server uses an optimization algorithm such as stochastic gradient descent or an adaptive variant (e.g., Adam) to update the network's weight parameters. The server divides the training data into mini-batches and iteratively processes each batch by computing forward activations and backpropagated gradients. The server uses a validation subset to monitor overfitting and performs early stopping when the validation error stops improving. By automating this training loop within the server, the system achieves improved prediction accuracy and stable convergence without manual hyperparameter tuning each time.

The server stores the trained prediction model parameters in the storage device using a standardized serialization format, such as a saved model format. The server also stores metadata describing the feature layout, normalization parameters, and timestamp of training. This allows the server to reload the model efficiently and apply it to new data without retraining from scratch, thereby improving runtime efficiency.

The server uses the trained prediction model to generate prediction information. The server constructs input feature vectors from the most recent historical information and external environment information, including up-to-date market indices and competitor prices. The server executes the model inference on batches of input vectors, producing predicted demand quantities, expected revenue, inventory indicators (e.g., expected days of cover), and price elasticity estimates for each item and time horizon. The server writes these outputs back into data frames, which form structured prediction information.

The server formulates an optimization problem by defining an objective function over decision variables such as replenishment quantities, prices, and promotional intensities. For example, the server may define an objective function to maximize total predicted profit or minimize total stock-out risk subject to constraints. The server encodes constraint conditions such as maximum warehouse capacity, minimum gross margin per item, and total promotion budget in a constraint matrix representation. The server then uses an optimization algorithm, such as a linear programming or mixed-integer programming solver, to compute strategy candidate values. The solver runs as a software module on the server and directly consumes the prediction information as coefficients for the objective and constraints.

The server, by executing this numerical optimization step on structured matrices, avoids ad hoc, heuristic decision rules and instead uses a deterministic mathematical framework. This improves numerical consistency, repeatability, and efficiency, because the server can leverage sparse matrix operations and specialized solvers optimized for modern processor architectures.

The server generates strategy candidates comprising replenishment quantities per item, candidate sales prices within allowed ranges, and candidate promotion measures such as discount percentages and campaign durations. These candidates are stored in tables that directly reference item identifiers and time periods. The server then prepares input for a generative AI model by mapping these numeric and categorical values into a structured representation, such as key-value pairs or flattened feature vectors, which are then associated with corresponding textual tokens for consumption by the generative AI model.

In one embodiment, the server implements the generative AI model as a transformer-based neural network trained for natural language generation, akin to a large language model. The server runs this model on the same hardware or on dedicated accelerator hardware such as graphics processing units. The server defines a token embedding layer, multiple self-attention layers, and feed-forward layers configured to generate coherent text conditioned on an input prompt.

The server constructs a prompt sentence to be input to the generative AI model. The server uses a template-based approach: it inserts summarized prediction information and strategy candidates into parameterized textual templates. For example, the server generates a prompt sentence such as:

“The system predicts a 25% increase in demand for Product X next month and a 15% decrease for Product Y. Current stock levels are 500 units for Product X and 2,000 units for Product Y. Generate a detailed inventory adjustment and promotion plan for the next 4 weeks, including reorder quantities, discount recommendations, and timing of campaigns.”

In another example, the server generates a prompt sentence such as:

“Recalculate the one-month sales and inventory strategy under the following constraints: maximum warehouse capacity is 10,000 units in total, minimum gross margin per item is 20%, and total promotion budget is 5,000 monetary units. Based on the updated recommendations, propose a weekly plan for restocking, price adjustments, and promotions, ensuring that all constraints are satisfied.”

The server incorporates condition information, such as capacity limits and margin thresholds, directly into the prompt sentence so that the generative AI model can produce output that is consistent with the optimization results and user constraints. This combination of numeric optimization and textual conditioning enables the generative AI model to generate detailed management strategy proposals in natural language that match the underlying computed strategy.

The server sends the constructed prompt sentence and, optionally, structured auxiliary data to the generative AI model and executes inference. The model produces a sequence of tokens representing natural-language sentences. The server decodes these tokens into text, forming a management strategy proposal that includes structured recommendations such as “increase reorder quantity for high-demand items,” “reduce price for slow-moving items,” and “schedule weekend promotions for specific categories.” The server stores this text in a reporting database and associates it with the corresponding prediction and strategy candidate records.

The terminal operates as a user interface device, such as a personal computer, tablet, or smartphone. The terminal executes a client application or a web browser that communicates with the server via a network using a communication protocol such as HTTPS. The terminal displays the management strategy proposals in a user interface that may include tables, charts, and narrative sections. The terminal requests data from the server through an application programming interface and renders the responses for display.

The user operates the terminal to review the generated management strategy proposals. The user may input constraint condition information, such as updated maximum warehouse capacity, revised margin targets, or new promotion budgets, through input forms on the terminal. The terminal validates the input, for example by checking that numeric values are within valid ranges, and transmits the constraint condition information and priority information to the server via API calls.

The server receives the updated constraint condition information and modifies the objective function and constraint matrices accordingly. The server then re-executes the optimization algorithm using the same prediction information but with the new constraints. The server recomputes strategy candidates and regenerates a prompt sentence that reflects the revised conditions, then invokes the generative AI model again to obtain an updated management strategy proposal. This closed-loop process allows the server to dynamically adapt strategy proposals to evolving constraints without human operators recomputing all values manually.

The user may provide evaluation information and feedback information through the terminal interface, such as approvals or rejections of specific recommendations or comments describing observed outcomes (e.g., “stock-out occurred earlier than predicted”). The terminal records this feedback and transmits it to the server. The server stores the feedback in dedicated feedback tables and periodically uses this data during retraining of the prediction model and fine-tuning of the generative AI model. For example, the server may assign higher weights to training examples where prediction errors were large or where user feedback indicated dissatisfaction, thereby reducing similar errors in future predictions.

In one variation, the server performs incremental learning by periodically updating model weights using newly arriving data without rebuilding models from scratch. The server uses techniques such as mini-batch online learning and learning rate scheduling to adjust the speed of adaptation. In another variation, the server uses alternative model architectures such as gradient boosting machines for prediction or different transformer configurations for the generative AI model. The server may also employ dimensionality reduction techniques or sparse representations for feature vectors to further improve computational efficiency.

By integrating a structured data processing pipeline, a prediction model, an optimization engine, and a generative AI model with automated prompt sentence generation, the server improves computer technology in several ways. The server reduces the amount of manual data preparation and formatting typically required before model training and prediction, thereby lowering latency and increasing throughput. The server designs its feature engineering and model training to exploit cache locality and vectorized operations, improving processing speed on large datasets. The server's optimization module converts prediction outputs into mathematically coherent strategy candidates, reducing redundant computations and eliminating iterative, manual spreadsheet-based adjustments.

Furthermore, the server's integration of generative AI is not a simple automation of human drafting. The server systematically transforms numeric optimization outputs and constraint information into structured prompt sentences that drive the generative AI model to produce context-aware textual strategies. This leads to a technically improved pipeline where the generative AI model is tightly coupled to prediction and optimization modules, rather than being used as a generic text generator. The closed-loop feedback mechanism provides continuous refinement of both predictive accuracy and natural-language generation quality, improving the reliability and efficiency of the overall system over time.

In other embodiments, the server may support additional hardware configurations, such as deployment on multiple nodes in a distributed computing cluster, utilization of hardware accelerators such as tensor processing units, or adaptation to different types of electronic transaction platforms. The terminal may be implemented as any network-enabled device capable of sending and receiving structured messages, and the user may be an operator responsible for monitoring system outputs and providing constraints and feedback. These variations can be applied without departing from the technical spirit of using an integrated, computer-implemented pipeline to generate and refine management strategy proposals through combined predictive modeling, optimization, and generative AI processing.

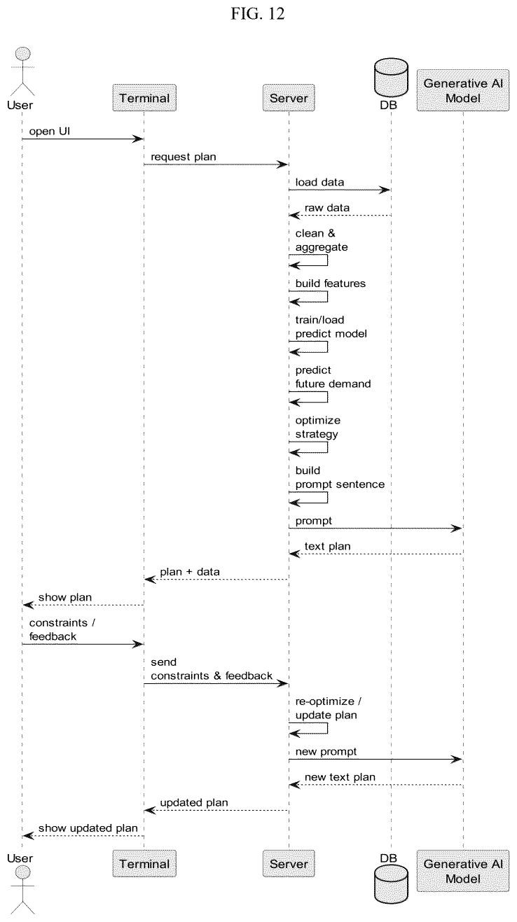

The following describes the processing flow using FIG. 12.

### Step 1:

The server acquires raw data.

The server receives, as input, historical information (including past transaction records, inventory logs, and demand logs) and external environment information (including market trend series and competitor price series) from a storage device such as a relational database.

The server issues structured queries, retrieves result sets, and loads them into main memory as tabular objects. Based on the input tables, the server performs type conversion, such as converting date strings into timestamp formats and mapping textual item identifiers to normalized codes, and outputs normalized raw data tables ready for analysis.

### Step 2:

The server performs data cleaning.

The server takes, as input, the normalized raw data tables from Step 1 and scans each column to detect missing values and inconsistent entries. The server applies missing-value processing by computing statistical measures (for example, median price per item group) and filling gaps accordingly, and it flags invalid entries such as negative quantities. The server outputs cleaned data tables in which missing and invalid values are either imputed or removed, so that subsequent computations operate on consistent data.

### Step 3:

The server performs outlier handling.

The server receives, as input, the cleaned data tables from Step 2 and calculates distribution statistics such as means, standard deviations, and interquartile ranges for numeric fields including quantity and price. The server computes outlier scores (for example, z-scores) and compares them with predefined thresholds. When the server detects outliers, the server either clips the values to upper or lower bounds or removes the corresponding records based on configured rules. The server outputs outlier-adjusted data tables with stabilized numeric ranges, which improve numerical stability for later modeling.

### Step 4:

The server performs aggregation processing.

The server uses, as input, the outlier-adjusted data tables from Step 3 and groups records by keys such as item identifier and time interval (e.g., per day or per week). The server calculates aggregated metrics including total quantity sold, average unit price, total revenue, and number of transactions per group by scanning each group and applying sum, mean, and count operations. The server outputs aggregated tables in which each row represents an item-time combination with associated aggregate metrics, forming a compact representation of historical behavior.

### Step 5:

The server performs time-series feature generation.

The server takes, as input, the aggregated tables from Step 4, ordered by time for each item.

The server generates lag features by shifting aggregates (for example, previous 7-day sales, previous 30-day sales) and computes rolling statistics such as moving averages and moving standard deviations using sliding time windows. The server also attaches external environment information, such as market index values and competitor prices aligned to the same time axis. The server outputs time-series feature tables where each row contains both current and historical feature values for a given item and time point.

### Step 6:

The server encodes categorical variables.

The server receives, as input, the time-series feature tables from Step 5 that include categorical fields such as item category, customer segment, and region. The server applies encoding processing, for example one-hot encoding or ordinal encoding, to convert these categorical fields into numeric vectors. The server merges the encoded columns with the existing numeric columns and removes or replaces the original categorical columns. The server outputs fully numeric feature tables suitable for input to machine learning algorithms.

### Step 7:

The server constructs training and inference datasets.

The server uses, as input, the numeric feature tables from Step 6 and the corresponding target variables such as future demand or revenue at specified horizons. The server splits the data into training, validation, and test sets based on time or random sampling, and then packages each set into in-memory arrays or tensors. The server normalizes or standardizes selected features (for example, scaling each feature to zero mean and unit variance) to facilitate stable learning. The server outputs structured datasets composed of input feature matrices and target vectors for use by prediction models.

### Step 8:

The server trains a prediction model.

The server takes, as input, the training and validation datasets from Step 7. The server initializes a neural network architecture, for example a feed-forward network with multiple hidden layers or a recurrent network with long short-term memory units, and assigns random initial weights. The server iteratively feeds mini-batches of input features into the network, computes predicted outputs, evaluates an error function such as mean squared error against the target values, and backpropagates gradients to update the weights using an optimization algorithm such as Adam. The server monitors validation error to determine when to stop training and selects the weight configuration that minimizes validation error. The server outputs a trained prediction model together with learned parameters and associated preprocessing metadata.

### Step 9:

The server generates prediction information.

The server uses, as input, the trained prediction model from Step 8 and the most recent feature data for future time horizons derived from the numeric feature tables. The server applies the same scaling and transformation used during training to the new feature data, feeds the transformed feature matrices into the trained model, and computes predicted values for future demand, revenue, inventory indicators, and price elasticity for each item and time point. The server aggregates these model outputs into prediction tables that associate each item-time pair with predicted metrics. The server outputs prediction information tables that serve as quantitative input for optimization.

### Step 10:

The server formulates and solves an optimization problem.

The server takes, as input, the prediction information from Step 9 and configuration data representing objective function parameters and constraint conditions, such as target profit, warehouse capacity, minimum margin, and promotion budget. The server constructs an optimization model by representing decision variables (e.g., replenishment quantities, prices, promotion intensities) and attaching coefficients derived from the prediction information to the objective function and constraints. The server then invokes an optimization solver to compute values of the decision variables that maximize or minimize the objective while satisfying the constraints. The server outputs strategy candidate tables containing optimized replenishment quantities, candidate prices, and candidate promotion measures for each item and period.

### Step 11:

The server generates structured strategy representations.

The server receives, as input, the strategy candidate tables from Step 10. The server combines these with item metadata (e.g., item name, category) and frame them into structured records describing, for each item and time interval, recommended target inventory, price, and promotion settings. The server computes additional derived indicators, such as projected stock cover days and expected promotion lift, by performing arithmetic operations on predicted demand and optimized decision variables. The server outputs structured strategy representations that can be both machine-readable and human-interpretable.

### Step 12:

The server constructs a prompt sentence for a generative AI model.

The server uses, as input, the structured strategy representations from Step 11 and distilled prediction summaries such as major demand increases or decreases. The server selects salient items and metrics based on ranking criteria (for example, top items by revenue impact or largest projected change) and inserts these values into text templates. By concatenating fixed text segments with formatted numeric values and constraint descriptions, the server generates a prompt sentence that instructs a generative AI model to produce a detailed management plan. The server outputs a textual prompt sentence, such as:

“The system predicts a 25% increase in demand for Product X next month and a 15% decrease for Product Y. Current stock levels are 500 units for Product X and 2,000 units for Product Y. Generate a detailed inventory adjustment and promotion plan for the next 4 weeks, including reorder quantities, discount recommendations, and timing of campaigns.”

### Step 13:

The server invokes the generative AI model to create a natural-language plan.

The server takes, as input, the prompt sentence from Step 12 and optional auxiliary structured data derived from the strategy candidate tables. The server tokenizes the prompt sentence into a sequence of tokens, feeds the token sequence into a generative AI model such as a transformer-based language model, and computes output token probabilities step by step. The server samples or selects tokens according to those probabilities to form coherent sentences that describe inventory actions, pricing changes, and promotion schedules. The server decodes the generated tokens into natural-language text and outputs a management strategy proposal document in textual form.

### Step 14:

The terminal displays the management strategy proposal and collects user inputs.

The terminal receives, as input, the management strategy proposal text and associated structured strategy representations from the server. The terminal renders the textual content in a graphical user interface, optionally alongside tables or charts summarizing key figures. The user interacts with the terminal to read the recommendations and to input constraint condition information and priority information, such as new capacity limits or targeted product categories, through forms or interactive controls. The terminal validates the input formats and outputs structured user input data to be sent back to the server.

### Step 15:

The server updates strategies based on user constraints.

The server receives, as input, the user-provided constraint condition information and priority information from the terminal together with the existing prediction information and strategy candidates. The server modifies the optimization model by adjusting constraint bounds and weighting terms in the objective function according to the received information. The server re-runs the optimization solver to compute updated decision variables that satisfy the new constraints, regenerates structured strategy representations, and constructs a revised prompt sentence reflecting the updated conditions. The server outputs updated management strategy proposals to the terminal.

### Step 16:

The user provides evaluation and feedback information.

The user reviews, as input, the updated management strategy proposals displayed on the terminal. The user approves or rejects specific recommendations, annotates reasons for changes, and may later provide actual outcome data (for example, actual sales versus predicted sales) through the terminal interface. The terminal collects this evaluation and feedback information and transmits it to the server, which records it in feedback tables. The server later uses this feedback as input for retraining the prediction model and fine-tuning the generative AI model, thereby outputting improved model parameters and enhancing future prediction and generation performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented decision support systems for management strategy typically apply fixed statistical analyses or generic machine learning algorithms to business data and then present static recommendation lists to users. Such systems suffer from several technical limitations in the way information is acquired, preprocessed, transformed into model inputs, and fed back into the models.

First, existing systems often lack a structured pipeline that converts heterogeneous business data (for example, different file formats, inconsistent schemas, and noisy records) into a unified, cleaned, and summarized representation that is specifically optimized for consumption by a generative AI model. As a result, the input to the model is either incomplete or unnormalized, which leads to suboptimal utilization of computing resources and degraded quality of generated outputs.

Second, conventional architectures do not clearly separate and coordinate the roles of a management-side server and a user-side terminal at the level of prompt handling and context construction. In many implementations, the prompt sentence input by the user is either passed directly to the model without systematic integration of data-derived summaries, or the integration logic is ad hoc and confined to user interface scripts. This causes inefficient use of the model's context window, redundant network traffic, and inconsistent behavior across sessions, thereby limiting scalability and robustness of the computer system.

Third, existing systems typically treat user feedback as an informal or manual process, rather than as structured data that is tightly coupled to the exact prompts, context information, and model outputs that generated the feedback. Without such explicit associations, computer-implemented learning or adaptation processes cannot reliably detect evaluation patterns in user feedback, and thus cannot automatically adjust input conditions, output post-processing conditions, or model selection conditions. Consequently, the computing system does not effectively improve its behavior over time at the system level, and the same ineffective or misaligned recommendations may be repeatedly generated.

Fourth, conventional decision support solutions frequently embed domain-specific logic directly in application code, making it difficult to adapt the system to new domains, different organizational structures, or evolving data sources. Because there is no generic mechanism in the computing architecture for transforming raw data into summary indicators, composing those indicators with user prompt sentences into context information, and then dynamically adjusting the generative AI workflow based on feedback patterns, substantial developer effort is required to reconfigure or extend the system. This increases maintenance costs and reduces the technical flexibility of the platform.

Accordingly, there is a need for an improved computer-implemented system that: (i) standardizes and automates data cleaning, normalization, and summarization specifically for generative AI inputs; (ii) systematically combines structured summaries and user-entered prompt sentences into context information for a generative AI model; (iii) structurally captures and aggregates user feedback in association with the exact prompts, contexts, and outputs that produced it; and (iv) automatically modifies model input conditions, output structuring processes, or model selection policies based on detected evaluation patterns. Such a system should improve the overall operation of the underlying computer technology, including resource utilization, model effectiveness, and adaptability of the generative AI-based decision support pipeline.

The specific processing by the specific processing unit 290 of the data processing device 12 in Example 2 is realized by the following means.

The present invention provides a server comprising a processor configured to collect past business information, external environment information, and other organization information, to convert the collected information into structured information that is processable by information analysis processing, to perform preprocessing on the structured information including missing-value completion processing, outlier removal processing, and format unification processing, to generate summary indicators and summary description information from the preprocessed information, to receive a prompt sentence input in natural language by a user, to generate context information by combining the prompt sentence with at least part of the summary description information, to operate a generative information processing model using the context information as input so as to generate natural language output information including management policy proposals, to analyze the natural language output information and extract a plurality of policy proposals, numerical proposal information and assumption information and structure and store such extracted information, to present the natural language output information and the structured information to a terminal device for display to the user, to receive feedback information including evaluation information and opinion information from the terminal device, and to store the feedback information in association with the prompt sentence, the context information, and the natural language output information and to update at least one of the generative information processing model and control conditions for context information generation and output post-processing on the basis of aggregated feedback information. This enables the underlying computer system to automatically transform heterogeneous business data into cleaned and summarized model-ready context, to efficiently orchestrate interaction between server-side processing and terminal-side prompt input, and to iteratively adapt generative AI behavior based on structured user feedback, thereby improving the technical performance, scalability, and adaptability of computer-implemented decision support for management strategy.

The term “past business information” refers to data representing historical activities and performance of an organization, including but not limited to revenue, cost, profit, sales volume, and operational metrics recorded over one or more past periods.

The term “external environment information” refers to data representing conditions outside an organization that may affect the organization's operations, including but not limited to market trends, regulatory changes, macroeconomic indicators, and industry statistics.

The term “other organization information” refers to data representing attributes or activities of entities different from a target organization, including but not limited to competitor information, partner information, and benchmark organization metrics.

The term “structured information” refers to information that is organized into a predefined format suitable for machine processing, such as tabular data with defined fields, records, and data types that can be processed by analytical algorithms.

The term “information analysis processing” refers to computer-implemented operations that transform, aggregate, or evaluate data in order to derive metrics, patterns, or insights, including statistical analysis, data mining, and machine learning-based analysis.

The term “preprocessing” refers to operations performed on raw or structured data to improve its quality and consistency before subsequent analysis or model input, including cleaning, normalization, transformation, and selection of data.

The term “missing-value completion processing” refers to a type of preprocessing in which absent or undefined data entries are identified and replaced with substitute values, such as imputed estimates, defaults, or interpolated values.

The term “outlier removal processing” refers to a type of preprocessing in which data values that deviate from expected ranges or distributions beyond a defined threshold are detected and excluded or adjusted to reduce noise and improve data reliability.

The term “format unification processing” refers to a type of preprocessing in which heterogeneous representations of similar information, such as different date formats, numeric formats, or categorical labels, are converted into a consistent and standardized format.

The term “summary indicators” refers to aggregated numerical or categorical metrics derived from detailed data, such as averages, totals, growth rates, ratios, or key performance indicators that compactly describe the state of the data.

The term “summary description information” refers to textual or symbolic representations that explain or contextualize summary indicators, such as narrative descriptions of trends, anomalies, or comparative results generated from underlying data.

The term “prompt sentence” refers to a natural language instruction or query input by a user, intended to guide the behavior of a generative AI model by specifying a task, constraint, or objective for the model to address.

The term “context information” refers to composite data provided as input to a generative AI model, including at least a prompt sentence and one or more additional elements such as summary description information, constraints, or system-level instructions.

The term “generative information processing model” refers to a computational model, such as a generative machine learning model, configured to receive input information and produce new information, including natural language text, based on learned patterns.

The term “natural language output information” refers to content generated by a generative information processing model in human-readable language, such as sentences and paragraphs describing analysis results, recommendations, or explanations.

The term “management policy proposals” refers to natural language output information that suggests actions, strategies, or guidelines for operating or governing an organization, including recommended allocations of resources, strategic priorities, and process changes.

The term “policy proposals” refers to individual suggested courses of action or strategies, expressed in natural language, that form part of management policy proposals.

The term “numerical proposal information” refers to quantitative elements included in or derived from policy proposals, such as specific percentages, amounts, thresholds, or ranges recommended for implementation.

The term “assumption information” refers to explicit or implicit conditions, premises, or prerequisites stated in or inferred from policy proposals, indicating circumstances under which the proposals are expected to be valid or effective.

The term “structured information” (as used for results) refers to policy proposals, numerical proposal information, and assumption information that have been parsed, labeled, and organized into a machine-readable format such as records, fields, or data structures.

The term “information display device” refers to a hardware component configured to visually present information to a user, such as a display screen, monitor, or panel associated with a terminal or computing device.

The term “terminal device” refers to a computing device operated by a user to input and receive information over a network, such as a personal computer, tablet, smartphone, or similar communication device.

The term “evaluation information” refers to data representing a user's assessment of generated outputs, including but not limited to ratings, rankings, selection of predefined evaluation options, or binary indicators of usefulness.

The term “opinion information” refers to free-form or semi-structured textual comments, annotations, or explanations provided by a user regarding generated outputs or system behavior.

The term “feedback information” refers to a combination of evaluation information and opinion information acquired from a user in response to generated outputs, and that is used to adjust or improve system behavior.

The term “management information processing apparatus” refers to a computing system, typically implemented as a server or server cluster, configured to perform centralized processing tasks including data preprocessing, context generation, and model execution.

The term “communication terminal apparatus” refers to a device distinct from the management information processing apparatus, configured to send user inputs such as prompt sentences and feedback information to the server and to receive and display output information from the server.

The term “aggregation processing” refers to operations that combine multiple items of feedback information into collective metrics or distributions, such as averages, counts, or frequencies over specified categories.

The term “classification processing” refers to operations that assign feedback information or derived metrics to one or more predefined or learned categories, such as usefulness levels, applicability types, or error types.

The term “evaluation patterns” refers to recurring combinations or trends in feedback information, identified through aggregation processing or classification processing, that indicate systematic user responses to particular types of proposals or outputs.

The term “usefulness tendencies” refers to evaluation patterns indicating that certain proposals or proposal types are frequently assessed positively or deemed helpful by users.

The term “mismatch tendencies” refers to evaluation patterns indicating that certain proposals or proposal types are frequently assessed negatively or deemed irrelevant, infeasible, or inconsistent with user needs.

The term “input conditions for the generative information processing model” refers to settings or constraints that govern how input information is prepared and provided to the model, including selection or weighting of context components, prompt templates, and parameter values.

The term “output post-processing conditions” refers to rules, parameters, or algorithms applied to raw model outputs in order to transform, filter, segment, or reformat the outputs into final structured information.

The term “model selection conditions” refers to criteria or rules that determine which generative model, model version, or model configuration is chosen for a given context or request, including factors such as domain, feedback patterns, or computational constraints.

In one embodiment, a server, a terminal, and a user cooperate to implement the claimed system using conventional computing hardware and specialized software modules that improve how a generative AI model is supplied with data and feedback in a management decision-support context.

The server includes at least one processor, a main memory, a non-volatile storage device, and a network interface. The server runs an operating system such as a general-purpose server operating system and executes application programs implemented, for example, using a web application framework such as a scripting-language-based framework or an object-oriented application framework. The server further uses a data processing library such as a columnar data-processing library or a distributed data-processing engine, and a database system such as a relational database management system or a distributed data warehouse. The server accesses a generative AI model through a machine learning framework such as a numerical-computation-based deep learning framework or a tensor-based deep learning framework, or through an external model-serving API.

The terminal includes a processor, a memory, a display (for example, a liquid crystal display or organic light emitting diode display), an input device (for example, a keyboard, mouse, or touch panel), and a network interface. The terminal runs a client operating system and executes a web browser or a native application. The terminal communicates with the server via a network protocol such as HTTPS over TCP/IP. The user operates the terminal to upload data, input a prompt sentence, and provide feedback.

The user operates a business application, for example, a spreadsheet application or a reporting tool, on a personal computer or other terminal device to prepare past business information, external environment information, and other organization information. The user exports the information in digital file formats such as CSV or spreadsheet workbooks and stores them on a local storage medium. The user then activates a web browser, accesses a web page served by the server, and selects the prepared files through a graphical user interface. The user may combine multiple files and confirm metadata such as the relevant business period before sending the files to the server.

The server receives the uploaded files via an HTTP server component and stores the raw files in a storage area, such as a file system directory or an object storage. The server registers metadata including file path, user identifier, timestamps, and logical dataset identifiers in a database table. The server loads the raw files using a data processing library. The server detects data types, such as numeric, categorical, and date types, and stores the parsed data in a columnar in-memory structure. The server thereby converts the collected information into structured information that is processable by information analysis processing.

The server executes preprocessing operations on the structured information. The server performs missing-value completion processing by scanning each column to locate null or empty entries and substituting these values according to predefined rules, such as median imputation, last-observation-carried-forward, or domain-specific default values. The server applies outlier removal processing by computing distribution statistics such as mean and standard deviation or quantiles for each numeric attribute, flagging values that exceed a threshold (for example, more than a specified number of standard deviations from the mean), and either excluding those records or capping the values within a defined range. The server executes format unification processing by normalizing date formats into a common internal representation, normalizing numeric formats (for example, decimal separators and thousands separators), converting currency values into a reference currency by applying exchange-rate tables, and mapping textual category labels to standardized codes. The server stores the preprocessed information as a cleaned dataset, for example, in a columnar file format or as a dedicated table in the database.

The server derives summary indicators and summary description information from the cleaned dataset. The server calculates aggregated metrics, such as total sales by quarter, average unit price by product group, year-over-year growth rates, ratios between marketing expenditures and revenues, and distribution statistics for key variables. The server stores these numerical metrics in a dedicated summary table with fields such as metric identifier, time period, and value. The server then generates summary description information by applying rule-based or template-based natural language generation on the summary table, such as “Sales in Region A increased by 12% year-over-year, while sales in Region B decreased by 3%.” The server stores the generated text snippets as summary description records associated with the corresponding dataset.

The user reviews, on the terminal, which dataset and period to use, by interacting with a user interface rendered by a front-end framework such as a reactive JavaScript framework or a component-based UI library. The terminal requests from the server a list of available datasets and summary indicators, and displays them on the display device. The user selects a dataset and then inputs a prompt sentence into a text field. Example prompt sentences include:

“Please analyze the latest quarterly data and propose three concrete marketing strategies to increase sales of Product X by at least 10% next year.”

“Please propose a comprehensive marketing strategy for the next fiscal year based on the latest sales performance data, market trend indices, and competitor growth rates. Focus on digital channels and cost efficiency.”

“Given our last three years of revenue by product line and the provided market forecast, suggest three alternative growth strategies and discuss the main risks and assumptions for each strategy.”

“Analyze the sales, advertising spend, and customer acquisition data, and identify which channels should receive increased budget next quarter. Provide specific percentage changes and justification.”

“Based on the current market share data and competitor activity summary, recommend strategic actions to defend our market position and to enter one new segment within the next 12 months.”

The terminal transmits the prompt sentence, together with dataset identifiers and optional configuration parameters, as a request to the server. The server records the prompt sentence and retrieves the corresponding summary description information and summary indicators from the database. The server constructs context information for the generative AI model by composing the prompt sentence with the summary description information under a predefined template, such as: “Business context: [summary description information]. Task: [prompt sentence]. Constraints: [optional rules].” The server may also insert system-level instructions indicating the desired output format, maximum length, and level of detail.

In one embodiment, the server uses a generative AI model implemented as a transformer-based neural network. The server stores the neural network parameters in a model repository and loads the model into memory through a deep learning framework. The model includes a plurality of layers of self-attention and feed-forward sublayers, with an embedding layer for token representations and a final linear layer projecting hidden states to token logits. The server tokenizes the context information using a tokenizer compatible with the model, converts tokens into integer identifiers, and generates input sequences of token identifiers. The server controls parameters such as maximum sequence length, temperature, and top-k or top-p sampling thresholds for generation.

The server executes the generative AI model on a processor, which may include a central processing unit or a specialized accelerator such as a graphics processing unit. The server feeds the tokenized context to the model, which computes attention weights across tokens, updates hidden states through matrix multiplication and non-linear activation functions, and generates probability distributions over the next-token vocabulary at each step. The server iteratively samples tokens according to the specified sampling strategy until an end condition is reached, such as a stop token or a maximum output length. The server converts the generated token identifiers back into text, thereby obtaining natural language output information.

The server post-processes the natural language output information to extract structured policy proposals, numerical proposal information, and assumption information. The server applies parsing logic that may include regular expression matching, pattern-based segmentation, and phrase-level tagging. For example, the server identifies headings such as “Strategy 1,” “Strategy 2,” and “Strategy 3,” and splits the text into multiple policy proposals. The server detects numeric patterns such as “increase budget by 20%” or “reduce cost by 5%” and records the associated numeric values as numerical proposal information, setting fields for type of action, magnitude, and affected category. The server identifies textual patterns such as “assuming that,” “if,” or “provided that” and extracts the corresponding clauses as assumption information. The server stores the structured representation of each policy proposal in a database, with fields for textual description, numerical parameters, assumptions, and links to the originating prompt sentence and context information.

The terminal requests the generated output from the server and displays both the raw natural language output information and the structured summary on the display device. The terminal arranges the information into sections, such as a summary view showing key proposals and a detailed view listing all extracted numerical parameters and assumptions. The terminal allows the user to expand, collapse, or filter elements using user interface controls. The user can thereby review the technical effect of different recommendations efficiently.

The user evaluates the proposals by selecting evaluation options presented on the terminal, such as usefulness ratings or relevance flags, and by entering opinion information as free text comments. The terminal sends this feedback information to the server, linking it to the corresponding policy proposals and prompt sentence. The server stores the feedback information in a feedback table, which includes fields for evaluation scores, categories, comments, and identifiers of the associated prompt, context, and model output.

The server performs aggregation processing and classification processing on the feedback information. The server uses statistical routines to compute average usefulness scores per proposal type or per feature pattern in the context information. The server applies a machine learning classifier, implemented for example with a gradient-boosted decision tree or a smaller neural network, to categorize feedback as positive, neutral, or negative. The server derives evaluation patterns indicating usefulness tendencies or mismatch tendencies for particular combinations of prompt patterns and generated policy types.

The server uses the evaluation patterns to adjust at least one of the input conditions for the generative AI model, output post-processing conditions, and model selection conditions. For example, the server modifies prompt templates to emphasize or de-emphasize certain data elements in the context information when previous patterns show that particular emphasis leads to more useful outputs. The server adjusts sampling parameters such as temperature or penalty terms for repetitiveness to reduce occurrences of proposals that users repeatedly rate as mismatched. The server updates rules that select between multiple model variants, such as a model specialized for marketing strategies and another for cost optimization, based on domain-specific feedback patterns.

In some embodiments, the server fine-tunes a derivative generative AI model using feedback-enriched data. The server constructs training pairs consisting of context information and target output annotations derived from feedback, and optimizes the model's parameters by minimizing a loss function such as cross-entropy between model outputs and desired outputs, or a reinforcement-learning-based objective where rewards represent aggregated user evaluations. The server applies gradient-based optimization, updating model weights through backpropagation. The server thereby configures the generative AI model to produce outputs more aligned with user preferences when similar context information appears in the future.

This architecture improves computer technology in several ways. Because the server systematically cleans, normalizes, and summarizes heterogeneous data before creating context information, the generative AI model receives compact and high-signal inputs, reducing unnecessary token usage and lowering computational load. The separation of roles between the server and the terminal enables the server to centralize heavy preprocessing and model execution while the terminal focuses on user interaction, which reduces redundant processing at client side and optimizes network traffic by transmitting summarized data instead of full raw datasets.

The structured extraction of policy proposals, numerical proposal information, and assumption information enables the server to store and query generated outputs in a machine-readable format, improving data management and permitting efficient retrieval and comparison across sessions. This structure also allows automated aggregation and classification of feedback, enabling algorithmic adjustment of model behavior that is not achievable in purely manual or static systems.

Furthermore, the feedback-driven modification of context generation, parameter settings, and model selection introduces a non-conventional control loop within the computing system. Instead of simply automating human reasoning, the system alters the internal configuration of the generative AI pipeline based on statistically derived evaluation patterns, which improves accuracy, reduces repetitive or irrelevant outputs, and increases convergence speed to useful strategies. This results in technical benefits such as reduced processing time for subsequent requests, improved hit rate of relevant proposals, and more efficient use of computing resources.

The server can employ alternative implementations while remaining within the scope of the invention. For example, the data processing library may be replaced by any equivalent library capable of columnar processing and missing-value handling. The generative AI model may be hosted externally as a service, with the server performing tokenization and post-processing locally, or may be deployed on-premises using different neural network architectures such as encoder-decoder architectures or recurrent networks. The feedback analysis component may be implemented using unsupervised clustering to discover new evaluation categories. The terminal may be a mobile device, a desktop computer, or an embedded terminal in a conference room environment. These variations maintain the same essential data flow: structured data acquisition and preprocessing, context-based generative AI processing, structured output extraction, and feedback-driven configuration updates that jointly improve the performance and adaptability of the computer-implemented decision support system.

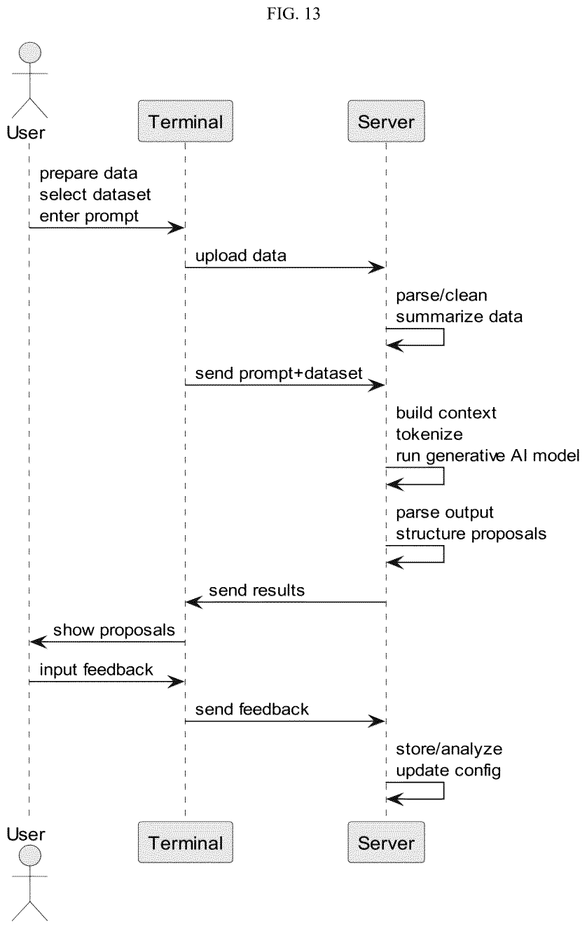

The following describes the processing flow using FIG. 13.

### Step 1:

The user prepares business data on a local computing device.

The user operates a spreadsheet application or business reporting tool to collect past business information, external environment information, and other organization information, and saves them as digital files such as CSV or spreadsheet workbooks. The input is raw business data in various original formats, and the output is one or more data files stored on a local storage medium, organized by period, business unit, or product category.

### Step 2:

The terminal sends the prepared data files to the server.

The terminal executes a web browser or native client and displays an upload screen. The terminal receives a user selection of files, attaches the files to an HTTPS request, and transmits the request to a designated upload endpoint of the server. The input is the selected local data files and user identification information, and the output is a network message containing the files and metadata sent to the server.

### Step 3:

The server receives and stores the raw data files.

The server runs an HTTP server component that accepts the incoming upload request, reads the file streams, and writes the files to a storage area such as a file system directory or object storage. The server registers file paths and metadata in a database table. The input is the uploaded file streams and associated metadata, and the output is stored raw data files and database records that reference the storage locations.

### Step 4:

The server parses the raw data files into structured information.

The server loads each raw file using a data processing library, automatically detects column separators, character encoding, and data types, and converts the content into in-memory tables. The server maps columns to standard field names and data types, such as numeric, categorical, and temporal types. The input is the stored raw data files from the storage area, and the output is structured information represented as standardized tables ready for preprocessing.

### Step 5:

The server performs missing-value completion processing.

The server scans each column of the structured tables to identify null or empty entries. The server computes statistical values such as mean, median, or mode per column or per segment, and then replaces missing entries based on predefined rules (for example, median for continuous values and mode for categorical values). The input is structured tables with missing entries, and the output is modified tables where missing values are filled with computed substitute values.

### Step 6:

The server performs outlier removal processing.

The server calculates distribution parameters, such as mean and standard deviation or interquartile ranges, for selected numeric columns. The server flags records whose values fall outside thresholds (for example, more than a specified number of standard deviations from the mean) and either removes such records or caps their values to boundary values. The input is tables with potentially extreme values, and the output is cleaned tables in which outliers are removed or adjusted to reduce noise.

### Step 7:

The server performs format unification processing.

The server normalizes date formats by parsing multiple date representations and converting them into a single internal format. The server harmonizes numeric formats, such as decimal separators and thousands separators, and converts currency values into a common reference currency using predefined exchange-rate tables. The server maps textual category labels to standardized codes using a mapping table. The input is cleaned tables with heterogeneous formats, and the output is format-unified tables using consistent internal representations for all fields.

### Step 8:

The server generates summary indicators from the preprocessed data.

The server executes aggregation queries that group records by time period, product category, geographical region, or other business dimensions, and computes metrics such as sums, averages, growth rates, and ratios. The server stores the results in separate summary tables with fields for dimension keys and aggregated metrics. The input is the preprocessed and format-unified tables, and the output is summary indicator tables representing compact numerical descriptions of the business data.

### Step 9:

The server generates summary description information from the summary indicators.

The server applies rule-based templates to the summary indicators to create short textual descriptions, such as “Sales in Region A increased by 12% year-over-year.” The server selects significant changes (for example, metrics above or below certain thresholds) and converts them into sentences, storing each sentence with references to the corresponding metrics. The input is summary indicator tables, and the output is summary description information composed of text snippets that explain key trends and anomalies.

### Step 10:

The terminal acquires dataset options and summary previews from the server.

The terminal sends a request for available datasets and their summary descriptions and receives a list from the server. The terminal renders this list on the display device, allowing the user to select a dataset and review basic summaries before generating strategies. The input is the user's request for dataset selection, and the output is a user interface displaying dataset identifiers and excerpts of summary description information.

### Step 11:

The user selects a dataset and inputs a prompt sentence.

The user chooses one of the available datasets displayed on the terminal, confirming the relevant period or scope. The user then types a prompt sentence into a text input field, specifying a desired analysis or strategy. Example prompt sentences include: “Please analyze the latest quarterly data and propose three concrete marketing strategies to increase sales of Product X by at least 10% next year.” The input is the dataset selection shown by the terminal and the user's domain intention, and the output is a specific prompt sentence entered into the terminal.

### Step 12:

The terminal sends the prompt sentence and dataset identifier to the server.

The terminal constructs a request payload including the prompt sentence, the identifier of the selected dataset, and optional configuration parameters. The terminal transmits this payload via HTTPS to a strategy-generation endpoint of the server. The input is the user-entered prompt sentence and dataset identifier, and the output is a structured network request that encapsulates the prompt and selection context sent to the server.

### Step 13:

The server retrieves corresponding summary indicators and summary descriptions.

The server reads the dataset identifier from the request, queries the database for associated summary indicators and summary description information, and loads them into memory. The server may filter or rank the summary description information based on recency or importance. The input is the dataset identifier and the database contents, and the output is a set of numerical summaries and text summaries ready to be combined with the prompt sentence.

### Step 14:

The server generates context information by combining the prompt sentence and summaries.

The server inserts the prompt sentence and selected summary description information into a predefined textual template that explicitly separates business context, task, and constraints. The server may truncate or compress less relevant summaries to respect a maximum length. The input is the user's prompt sentence and the summary description information, and the output is a single context string or message structure that encapsulates both the data-derived context and the user's requested task for the generative AI model.

### Step 15:

The server tokenizes the context information for the generative AI model.

The server applies a tokenizer associated with the generative AI model to split the context information into tokens and map each token to a numerical identifier. The server pads or truncates the sequence to a configured maximum length, and constructs attention masks for the model. The input is the context information string, and the output is a numerical sequence and accompanying masks, suitable as direct input to the generative AI model.

### Step 16:

The server executes the generative AI model to generate natural language output.

The server passes the tokenized context and masks to a transformer-based generative AI model implemented in a machine learning framework. The server controls parameters such as temperature and sampling parameters. The model performs multiple layers of self-attention and feed-forward computation to produce probability distributions over possible next tokens. The server iteratively samples tokens to form an output sequence, and then converts the sequence back to text. The input is the numerical representation of the context and model configuration parameters, and the output is natural language output information containing management policy proposals.

### Step 17:

The server parses the generated text into structured policy proposals.

The server scans the generated text to identify sections and headings that designate separate strategies, uses pattern-matching rules to split the text into individual proposals, and locates numeric expressions such as percentages and budget amounts. The server extracts these numeric values and associates them with the relevant proposal text as numerical proposal information. The server identifies conditional phrases that convey assumptions and stores them as assumption information linked to each proposal. The input is the natural language output information, and the output is a structured representation consisting of multiple records that hold proposal text, numerical values, and assumptions in a machine-readable form.

### Step 18:

The server stores the structured proposals and related metadata.

The server inserts each structured proposal record into a database table, including fields for proposal identifier, prompt identifier, summary context identifier, numeric parameters, and assumptions. The server also stores the full generated text and links it to the same identifiers for traceability. The input is the structured representation of the proposals, and the output is persistent records that allow later retrieval, comparison, and aggregation of proposals and their parameters.

### Step 19:

The server sends the generated text and structured data to the terminal.

The server packages the natural language output information and the structured proposal data into a response object, including identifiers and status information. The server transmits the response to the terminal via the established network connection. The input is the stored and in-memory proposal data, and the output is a network response that delivers both unstructured and structured results to the terminal.

### Step 20:

The terminal displays the recommendations and extracted details to the user.

The terminal receives the response and renders the generated text and structured proposal data in a graphical user interface. The terminal displays each proposal as a separate item, shows associated numeric parameters (for example, “increase digital advertising budget by 20%”), and lists corresponding assumptions. The terminal allows the user to scroll, expand, or collapse elements. The input is the response from the server, and the output is a visual representation of proposals and details on the display device.

### Step 21:

The user reviews the proposals and provides feedback.

The user reads the recommendations, judges their relevance and feasibility, and interacts with the terminal to select evaluation options (for example, star ratings or categorical options like “very useful” or “not suitable”). The user may enter opinion information as free text comments describing specific issues or positive aspects. The input is the displayed proposals and the user's assessment, and the output is a set of feedback items captured by the terminal, including ratings and comments.

### Step 22:

The terminal sends the feedback information to the server.

The terminal composes a feedback payload that includes proposal identifiers, evaluation scores, classification tags, and free text comments. The terminal sends this payload via HTTPS to a dedicated feedback endpoint on the server. The input is the user-provided evaluations and comments, and the output is a structured feedback message transmitted to the server for storage and analysis.

### Step 23:

The server stores and aggregates the feedback information.

The server receives the feedback payload, validates data types and ranges, and writes each feedback item to a feedback table in the database, associating it with the corresponding prompt sentence, context information, and generated proposals. The server periodically reads accumulated feedback and computes aggregated metrics, such as average usefulness score per strategy type or per feature pattern. The input is the raw feedback items and linked metadata, and the output is both stored feedback records and aggregated metrics that summarize user responses.

### Step 24:

The server analyzes feedback patterns and updates model-related conditions.

The server applies classification or clustering algorithms to the aggregated feedback data to detect evaluation patterns that indicate usefulness tendencies or mismatch tendencies for certain proposal types or context configurations. Based on the detected patterns, the server adjusts input conditions to the generative AI model, such as emphasizing certain summary descriptors or omitting specific data elements that consistently lead to low ratings. The server updates output post-processing rules, for example, by deprioritizing or filtering proposals with patterns historically rated poorly, and may switch between different model variants based on context categories. The input is aggregated feedback metrics and pattern analysis results, and the output is updated configuration parameters and rules that influence future context generation and generative AI model behavior.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented decision support systems are typically limited to rule-based dashboards or static analytical tools that apply fixed algorithms to historical data and present aggregated indicators to human decision-makers. Such systems do not dynamically integrate heterogeneous data sources, advanced learning-based prediction, natural-language generative models, and real-time emotion information from users into a unified processing pipeline on a single computing platform. As a result, several technical problems arise in the functioning of the computer systems themselves.

First, conventional systems lack an integrated mechanism in the processor to automatically transform raw, heterogeneous business-related information acquired from multiple internal and external information sources into analyzable data representations suitable for both machine-learning algorithms and generative AI models. Without consistent preprocessing within the processor, such as systematic handling of missing values, outlier removal, and normalization, the computing system suffers from unstable model performance, fragmented data flow, and increased latency, thereby degrading overall computational efficiency and reliability.

Second, conventional systems do not provide a processor-level architecture that generates a composite prompt sentence combining: (i) a user-supplied prompt sentence expressing a decision-making intent, and (ii) context information derived from prediction information and influence-factor information computed by machine-learning algorithms. In the absence of such tightly coupled prompt generation logic executed by the processor, the generative AI model operates on incomplete or poorly structured inputs, which leads to suboptimal utilization of computational resources and requires repeated manual interactions, increasing processing load and network overhead.

Third, existing systems generally treat user emotion as an external, non-technical factor and do not implement, within the processor, an emotion estimation model that consumes multimodal input (for example, voice information and image information) from terminals or measurement apparatuses, and converts such input into machine-usable emotion-state information. Without such an integrated emotion-processing path, the computing system cannot algorithmically adapt the content or expression of generated policies to the current emotional context, forcing users to manually iterate and edit system outputs and thereby undermining the responsiveness and usability of the computer-based interface itself.

Fourth, feedback from users regarding generated policies is often stored only as unstructured text or is not tightly linked to the internal control of prompt generation and the interaction with the generative AI model. Conventional systems thus lack a processor-controlled feedback loop that updates prompt generation rules or input/output control for the generative AI model based on accumulated feedback information. This limitation prevents the computing system from improving its own behavior over time, resulting in inefficient reuse of past computations and an inability to adapt to evolving user preferences and usage patterns.

Accordingly, there is a need for an improved computer-implemented system in which the processor is specifically configured to (a) acquire and preprocess business-related information for learning-based analysis, (b) generate context-rich composite prompt sentences for a generative AI model, (c) estimate user or participant emotion states from multimodal data and incorporate such states into the generation and adjustment of business policies, and (d) capture and exploit feedback information to update internal control logic. Such a configuration improves the functioning of the computer itself by enabling more coherent data pipelines, more efficient use of computational resources, and more adaptive control of generative processing within the processor.

The specific processing by the specific processing unit 290 of the data processing device 12 in Application Example 2 is realized by the following means.

The present invention provides a server comprising a processor configured to acquire business-related information including performance information, environment trend information, and competitor information from at least one external information source and at least one internal information source; convert the acquired business-related information into an analyzable data format by performing preprocessing including missing-value completion, outlier removal, and normalization; apply at least one learning-processing algorithm to the preprocessed data to calculate prediction information and influence-factor information and to identify, as the influence-factor information, factors that affect a business policy; receive, from a user terminal, instruction information including a prompt sentence; generate, based on the instruction information and context information including the prediction information and the influence-factor information, a composite prompt sentence for input to a generative AI model having a natural-language generation function; input the composite prompt sentence to the generative AI model and obtain, from the generative AI model, response information including a candidate business policy and an explanation of a basis for the candidate business policy; execute an emotion estimation model using at least one of voice information and image information obtained from at least one of the user terminal and a measurement apparatus to generate emotion-state information representing an emotion state of at least one of a user and a participant; adjust at least one of content and expression of the candidate business policy included in the response information in accordance with the emotion-state information to generate a corrected business policy that takes the emotion state into account; transmit structured information including the corrected business policy and related numerical information to the user terminal as output information for display control at the user terminal; and store feedback information including evaluation information and free-description information regarding the corrected business policy, the feedback information being obtained from the user terminal, and update at least one of generation rules of the composite prompt sentence and input/output control with the generative AI model based on the feedback information. This enables the computing system to perform an integrated sequence of data acquisition, preprocessing, learning-based analysis, context-rich prompt construction, generative policy creation, emotion-aware adjustment, and feedback-driven control refinement within the processor, thereby improving internal data flow coherence, reducing redundant user interaction, and enhancing the adaptability and efficiency of computer-implemented decision support.

The term “business-related information” refers to information used for management or operational decision-making, including but not limited to performance information, environment trend information, and competitor information obtained from internal and external information sources.

The term “performance information” refers to information representing results of business activities over time, including numerical indicators such as sales amounts, profits, costs, and volumes associated with products, services, regions, or customer groups.

The term “environment trend information” refers to information representing changes or tendencies in an external environment relevant to business activities, including market trends, macroeconomic indicators, industry statistics, and other environmental factors.

The term “competitor information” refers to information relating to organizations that provide goods or services competing with those of a subject organization, including pricing, product offerings, market share, and public financial or operational indicators.

The term “external information source” refers to an information providing entity or resource outside a subject organization, including publicly available databases, third-party data services, and network-accessible interfaces that supply business-related information.

The term “internal information source” refers to an information providing entity or resource within a subject organization, including internal databases, transaction logs, operational systems, and data warehouses that store business-related information.

The term “analyzable data format” refers to a data structure or representation that is suitable for computational processing by algorithms, including tabular data, feature vectors, or other structured formats that can be directly consumed by learning-processing algorithms and generative models.

The term “missing-value completion” refers to a processing operation that detects absence of data values in records and substitutes estimated or representative values, such as mean values, median values, or values inferred from other attributes.

The term “outlier removal” refers to a processing operation that identifies data points that significantly deviate from normal ranges or patterns and excludes or adjusts such data points to reduce their adverse impact on subsequent analysis.

The term “normalization” refers to a processing operation that scales or transforms numerical data values into a standardized range or distribution, thereby improving numerical stability and comparability for algorithmic processing.

The term “learning-processing algorithm” refers to an algorithm that derives patterns, parameters, or models from data through computational learning procedures, including supervised learning, unsupervised learning, and reinforcement learning methods implemented by machine learning or statistical techniques.

The term “prediction information” refers to information generated by application of a learning-processing algorithm to preprocessed data, representing estimated future values or behaviors such as forecasted performance metrics, probabilities, or classifications.

The term “influence-factor information” refers to information indicating the degree to which specific variables, conditions, or features contribute to or affect an outcome associated with a business policy, including factor importance scores, weights, or sensitivity measures.

The term “business policy” refers to a plan, guideline, or course of action for managing or operating a business, including strategies, operational procedures, and allocation of resources over a specified period.

The term “user terminal” refers to an information processing apparatus operated by a user, including general-purpose computing devices such as personal computers, mobile terminals such as smartphones and tablets, and other display-equipped devices capable of communication with a server.

The term “instruction information” refers to information provided from a user terminal to a server for the purpose of requesting processing, including a prompt sentence, options, parameters, or other input data indicating a user's intent or requirement.

The term “prompt sentence” refers to a text string or sequence of symbols representing an instruction, query, or request that is input to a generative AI model to guide generation of an output.

The term “context information” refers to information that supplements a prompt sentence and provides background or situational data to a generative AI model, including prediction information, influence-factor information, and other metadata relevant to generation of an output.

The term “composite prompt sentence” refers to a combined or extended prompt that includes at least a user-supplied prompt sentence and associated context information, formatted as an input sequence for a generative AI model.

The term “generative AI model” refers to a computational model based on artificial intelligence techniques that generates new data, including natural language text, conditioned on input such as prompt sentences and context information.

The term “natural-language generation function” refers to a capability of a computational model to produce sequences of words or symbols that form human-readable text in a natural language.

The term “response information” refers to information output from a generative AI model in response to a composite prompt sentence, including at least one candidate business policy and an explanation or reasoning associated with the candidate business policy.

The term “candidate business policy” refers to a proposed business policy generated by a generative AI model prior to any adjustment based on emotion-state information or other post-processing.

The term “basis for the candidate business policy” refers to explanatory information generated by a generative AI model that describes reasons, assumptions, or supporting facts underlying a candidate business policy.

The term “emotion estimation model” refers to a computational model that receives multimodal input data, including at least one of voice information and image information, and outputs emotion-state information representing an estimated emotional condition of at least one individual.

The term “voice information” refers to digital data representing acoustic signals produced by speech, including audio samples, features extracted from audio, and associated metadata.

The term “image information” refers to digital data representing visual content, including still images or video frames that may contain faces, gestures, or other visual indicators.

The term “measurement apparatus” refers to a device configured to acquire physical signals or observation data relevant to a user or participant, including imaging devices, microphones, and other sensors.

The term “emotion-state information” refers to information representing an estimated emotional condition of at least one of a user and a participant, including emotion categories, intensity values, and temporal variation indicators.

The term “corrected business policy” refers to a business policy generated by adjusting at least one of content and expression of a candidate business policy based on emotion-state information, such that the business policy accounts for an estimated emotional condition.

The term “structured information” refers to information organized according to a predetermined schema or format, such as hierarchical data, tabular data, or tagged segments, enabling systematic display, storage, and processing.

The term “output information for display control” refers to information sent from a server to a user terminal that specifies content and layout for presentation on a display, including text data, graphical data, and associated formatting instructions.

The term “feedback information” refers to information obtained from a user terminal regarding a corrected business policy, including evaluation information such as ratings or selection results and free-description information such as comments or textual opinions.

The term “evaluation information” refers to information that quantitatively or qualitatively indicates a user's assessment or judgment regarding a corrected business policy, including scores, flags, and categorical selections.

The term “free-description information” refers to information consisting of unconstrained text or symbols provided by a user to express opinions, reasons, or additional context regarding a corrected business policy.

The term “generation rules of the composite prompt sentence” refers to internal control data or procedures used by a processor to determine how to construct a composite prompt sentence from a prompt sentence, context information, and other parameters.

The term “input/output control with the generative AI model” refers to control logic executed by a processor for managing communication with a generative AI model, including selection of model parameters, formatting of input prompts, handling of responses, and application of post-processing.

Server, terminal, and user cooperate to implement embodiments of the invention. Server executes a computer program on dedicated hardware to perform acquisition, preprocessing, learning-based analysis, composite prompt construction, generative AI interaction, emotion-aware adjustment, and feedback-driven control refinement. Terminal captures user inputs and multimodal signals and displays structured outputs. User provides prompt sentences, observes generated policies, and supplies feedback.

Server operates on a computing platform comprising at least one processor, a main memory, a nonvolatile storage device, a network interface, and optionally one or more accelerators such as graphics processing units. Server runs an operating system such as a general-purpose server operating system and executes application programs including a database management system, a Web application framework, and machine learning libraries. Server optionally uses a relational database, a key-value store, and message queues as part of its data management infrastructure.

Terminal operates on a client computing device such as a portable terminal, a personal computer, or a head-mounted display. Terminal comprises a display unit, an input unit, a microphone, a camera, and a communication interface. Terminal runs a client program implemented as a Web application or native application and communicates with server via a packet-based communication network.

User interacts with terminal through graphical user interface components. User inputs natural language prompt sentences, reviews generated business policies, and provides evaluation and free-form comments.

### 1. Hardware and Software Configuration for Data Acquisition and Preprocessing

Server acquires business-related information from internal and external information sources. Server uses a relational database management system to access internal performance information stored in tables. Typical tables contain columns such as a time stamp field, a region identifier field, a product identifier field, a numeric quantity field, a numeric revenue field, and categorical labels for customer segments. Server uses an application programming interface client to access external environment trend information and competitor information from network-based sources. External responses are typically encoded as structured text and include arrays of time-stamped records containing indicator values.

Server stores all acquired records into a staging area in nonvolatile storage and mirrors them into in-memory data structures. Server uses a data processing library such as a table-manipulation library to represent each dataset as a table object comprising rows and columns.

Server implements missing-value completion by scanning each column for undefined entries and replacing them using column-wise summary statistics or model-based estimates. Server implements outlier removal by computing per-column statistics such as mean, standard deviation, and quantiles and marking data points that exceed predetermined thresholds.

Server either removes marked points or clamps them to boundary values. Server performs normalization by mapping numerical values into standardized ranges using linear transformations. Server encodes categorical attributes using one-of-many binary vectors or index-based encodings suitable for numerical processing.

Server thereby converts heterogeneous raw records into analyzable data formats. This preprocessing pipeline improves numerical conditioning for downstream algorithms, reduces variance introduced by anomalous samples, and lowers overall error rates of learned models.

Because server executes these steps automatically and consistently, the data flow remains stable and repeatable across requests, which improves caching efficiency and reduces redundant computations.

In a variation, server uses a distributed data processing engine for large-scale log data. In such an embodiment, server partitions input tables across multiple worker processes and performs missing-value completion, outlier detection, and normalization in parallel. This architecture reduces wall-clock preprocessing time and enables near real-time operation for high-volume environments.

### 2. Learning-Processing Algorithms and Internal Model Structure

Server applies learning-processing algorithms to the preprocessed data to compute prediction information and influence-factor information. In one embodiment, server uses a gradient-boosted decision tree model to predict future performance metrics such as sales volume for each product-region-time combination. Server constructs feature vectors from table columns (for example, lagged sales values, moving averages, encoded seasonality, encoded promotions, and environmental indicators) and associates each feature vector with a target variable such as observed future sales. Server trains the model using batch gradient boosting with an objective function defined as a mean squared error between predicted and observed targets and uses regularization parameters to prevent overfitting. Server measures feature importance based on gain or split frequency across the ensemble and stores importance scores as influence-factor information.

In another embodiment, server uses a neural network model implemented in a numerical computation library. Server defines a multilayer architecture comprising an input layer matching the dimension of feature vectors, one or more fully connected hidden layers with nonlinear activation functions such as rectified linear units, and an output layer producing one or more continuous predictions. Server trains the model using stochastic gradient descent or a variant such as Adam. Server defines a loss function as a weighted sum of mean squared error and a regularization term. During training, server iteratively updates weight parameters based on gradients of the loss with respect to weights. Server optionally applies learning rate scheduling, early stopping, and batch normalization to accelerate convergence and improve generalization.

Server computes prediction information by feeding latest feature vectors constructed from up-to-date business-related information into the trained models. Server computes influence-factor information by evaluating gradients of outputs with respect to inputs, by computing permutation importance, or by extracting learned weights. This computation provides quantitative contributions of each input feature to the output, which cannot be easily derived by manual inspection or simple rule-based systems.

Server stores prediction results and influence-factor information in structured data stores. Server may also compress intermediate results using columnar storage formats to reduce memory footprint and improve subsequent traversal speed.

Because server uses learning-processing algorithms optimized for vectorized computation on processor or accelerator hardware, server achieves substantial improvements in prediction accuracy and execution speed compared with traditional rule-based or spreadsheet-based approaches. Moreover, server can reuse trained models across multiple user requests, reducing repeated training cost.

### 3. Construction of Composite Prompt Sentences and Interaction with a Generative AI Model

Server generates a composite prompt sentence for a generative AI model using both user-provided instruction information and internally computed context information. Server receives from terminal a prompt sentence in natural language. For example, user may input:

“Propose a detailed marketing and pricing strategy to increase next quarter's revenue by 20%. Use my past three years of sales data and current market trends, and keep risk at a moderate level.”

or

“Using historical performance data, current market trends, and competitor information, generate a comprehensive strategy to increase our next quarter's revenue by 20%. Include prioritized initiatives, expected impact, required resources, and potential risks, and present the output in a structured bullet-point format.”

Server parses the prompt sentence using a language-processing component to identify requested objectives, constraints, and time horizons. Server then constructs context information objects containing summarized prediction information and influence-factor information. For example, server generates a textual summary:

“Forecasted revenue for Product A in Region X next quarter is 15% below target. The most important drivers are price discount level (importance 0.35), digital advertising spend (importance 0.25), and competitor price index (importance 0.20).”

Server embeds these summaries into a composite prompt sentence that concatenates or otherwise structurally combines: a system role description, the user's prompt sentence, and structured context segments. Server can format the composite prompt in a conversation-like structure comprising role-tagged segments or in a single extended text block with labeled sections.

Server uses a generative AI model configured as a large language model with a transformer architecture. The model comprises multiple layers of self-attention and feed-forward sublayers and is parameterized by a large set of learned weights. The model consumes tokenized text sequences and produces probability distributions over possible next tokens conditioned on previous tokens. Server controls decoding parameters such as temperature, top-k, and maximum output length to trade off between determinism and diversity.

Server sends the composite prompt sentence to the generative AI model through an application programming interface. The model generates response information, including a candidate business policy and an explanation or justification for each proposed action. Because the composite prompt includes machine-derived context, the generative AI model can incorporate up-to-date prediction information and influence-factor information directly into text generation, reducing the need for repeated probing by user and thereby reducing network traffic and latency.

Server optionally incorporates additional constraints into the composite prompt, such as output formatting requirements and domain-specific terminology guidelines. This prompt-engineering mechanism is implemented by deterministic rules and templates executed by server and not by user, which modifies the way in which the generative model is used and yields more structured and computationally manageable outputs.

### 4. Emotion Estimation Using Multimodal Input and Adjustment of Candidate Policies

Server executes an emotion estimation model using multimodal data obtained from terminal or measurement apparatus. Terminal captures audio signals from a microphone and image signals from a camera during user interaction. Terminal transmits sampled frames or compressed streams to server.

Server extracts voice features such as pitch contour, energy, speaking rate, and spectral coefficients. Server normalizes these features and inputs them into a classifier network implemented as a recurrent or convolutional architecture configured to output probabilities over emotion classes. Server extracts image features from facial regions detected using computer vision algorithms. Server uses a convolutional neural network trained on annotated emotion datasets to map facial images to emotion class probabilities. Server fuses acoustic-based and visual-based emotion estimates using a fusion mechanism such as weighted averaging or a small fully connected network. Server outputs emotion-state information in the form of categorical labels (for example, “anxious”, “confident”) and confidence values.

Server uses emotion-state information as an additional condition to adjust candidate business policies. Server applies rule-based transformations to the generated text, such as inserting risk mitigation sections when anxiety is detected, or requesting a rephrasing with more conservative tone from the generative model. In some embodiments, server constructs a secondary composite prompt sentence that includes both the original candidate policy and a description of emotion-state information, for example:

“The decision-maker appears moderately concerned about risk and slightly skeptical about aggressive expansion. Revise the following policy to reduce perceived risk and include more conservative options.”

Server then obtains a revised candidate from the generative model and merges or replaces sections accordingly. This process yields a corrected business policy that is automatically adapted to emotion-state information without requiring manual rewriting by user.

Because emotion estimation and emotion-based adjustment are performed algorithmically entirely within server, the overall system can modify content and tone of policies faster and more consistently than manual editing. The system thereby reduces cognitive load on user and provides smoother interaction.

### 5. Feedback Capture and Adaptive Control of Composite Prompt Generation

Server receives from terminal feedback information that includes evaluation information (such as numeric scores or binary approval flags) and free-description information (such as written comments). Server stores feedback records in a database together with identifiers linking them to corresponding composite prompts, prediction information snapshots, and candidate or corrected policies. This linkage enables historical analysis of which prompt structures and context selections lead to satisfactory outcomes.

Server analyzes free-description information using a text analysis pipeline. Server tokenizes comments, identifies sentiment polarity and emotional tone, and clusters frequently mentioned weaknesses or strengths. Server correlates evaluation scores with internal parameters such as which features were emphasized in context summaries or which decoding parameters were used by the generative model.

Server then updates generation rules of the composite prompt sentence by adjusting templates, weighting of which prediction indicators appear, and inclusion or exclusion of certain explanatory sections. For instance, if feedback indicates that long narratives are rarely fully read, server modifies templates to request concise bullet lists instead of lengthy paragraphs. Similarly, if feedback shows that emphasizing certain influence factors leads to higher acceptance rates, server adjusts selection logic to prioritize those factors.

Server also adjusts input/output control with the generative AI model by tuning temperature, maximum token limits, and error-handling behavior. Server may, for example, lower temperature for users who prefer stable, consistent recommendations and increase it for users who request creative alternatives.

This feedback-driven adaptation improves the functioning of the system over time. The system gradually learns to construct more effective composite prompts and to interpret outputs in ways that match user preferences, which reduces the number of iterations per decision and thus reduces computation and network traffic.

### 6. Example Usage Scenarios and Technical Effects

User uses terminal to request strategic advice. Terminal displays an input field into which user enters a prompt sentence such as:

“Propose a detailed marketing and pricing strategy to increase next quarter's revenue by 20%. Use my past three years of sales data and current market trends, and keep risk at a moderate level.”

Server acquires and preprocesses relevant data, computes predictions and influence-factor information, and constructs a composite prompt. Generative AI model returns a candidate policy that includes specific numerical recommendations and a rationale. Server estimates that user is moderately anxious based on voice and facial cues and therefore instructs the generative model to revise the candidate to add risk mitigation measures and scenario analysis. Server sends the corrected policy to terminal. User reviews the structured output, selects a subset of actions, and records feedback indicating that additional emphasis on pricing elasticity would be useful. Server updates its prompt generation rules so that future prompts include explicit references to elasticity metrics.

In another scenario, user in a production environment uses a head-mounted terminal to monitor operational metrics. User inputs a prompt such as:

“Analyze today's production line sensor data and worker emotion data, detect any bottlenecks or stress hotspots, and propose specific actions to improve throughput and reduce worker stress over the next 8 hours.”

Server acquires sensor streams from machinery and emotion-related signals from cameras. Server uses anomaly detection models to identify throughput degradations and uses the emotion estimation model to locate areas of high stress. Server then constructs a composite prompt summarizing these findings and instructs the generative AI model to propose adjustments such as reallocating personnel or modifying schedules. Because server maintains sensor data structures optimized for streaming access and uses efficient model inference pipelines on accelerators, the system can update recommendations at a high temporal resolution, providing tangible improvements in production stability and worker well-being.

### 7. Technical Improvements and Compliance with Subject-Matter Guidelines

Server improves computer technology by introducing specific non-conventional data structures and processing flows that increase computational efficiency and predictive accuracy. Server uses structured staging tables and feature matrices designed to support vectorized operations and batch inference. Server organizes micro-batches of user requests such that prediction computations can be reused across similar prompts, reducing redundant reading from disk and repeated model evaluations. This leads to measurable reductions in average response time and computation cost.

Server further improves data management by normalizing heterogeneous data streams into unified analyzable formats and maintaining metadata describing feature provenance and transformation history. This metadata enables server to apply consistent preprocessing rules across sessions and supports automated detection of schema changes or data quality issues. The interaction pattern between server and generative AI model is also technically distinctive. Instead of directly forwarding raw user text to the model, server constructs composite prompt sentences using deterministic templates that embed structured context and control instructions. This prompt-engineering mechanism is executed algorithmically and results in more compact and informative inputs, which in turn allows shorter outputs and reduces token-level computation. Network bandwidth and API consumption are thereby reduced.

Server implements emotion estimation using dedicated classification networks that operate on voice and image features. These networks employ specific architectures, loss functions, and training methods tailored to emotion recognition. Server uses their outputs as explicit control signals for downstream adjustments of language generation. This processing chain extends beyond mere automation of human judgment: server uses machine-learned models to detect patterns in high-dimensional signal spaces that are not tractable for real-time manual analysis.

Because server performs the entire pipeline-data acquisition, preprocessing, learning-based analysis, composite prompt construction, generative interaction, emotion-aware adjustment, and feedback-based parameter tuning-within a coordinated architecture, the system achieves technical effects such as faster convergence of predictions, reduced variance in model outputs, reduced user interaction steps, and lower communication overhead between client and server. These effects improve the operation of the computer system itself, independent of any particular business context.

### 8. Alternative Embodiments and Variations

Server can employ different model architectures for learning-processing algorithms, such as convolutional models for time series, recurrent networks for sequence prediction, or probabilistic graphical models for structured dependencies. Server can choose algorithms based on data characteristics while maintaining the same high-level functions of generating prediction information and influence-factor information.

Server can implement emotion estimation using alternative modalities, such as physiological sensors measuring heart rate or skin conductance, provided by measurement apparatus. Server then extends the emotion-state information structure to include these signals and adjusts fusion rules accordingly.

Terminal can be realized as a wearable device, a stationary kiosk, or an in-vehicle unit, provided it can capture prompt sentences and multimodal signals and render structured outputs. In all cases, terminal primarily serves as an interface between user and server, while server performs core computational tasks.

User can interact using voice commands instead of text input. In such embodiments, terminal includes local speech recognition or relies on a remote recognition service, and the resulting transcribed text is treated as a prompt sentence.

These variations do not materially change the core architecture in which server is configured to process business-related information, generate composite prompt sentences, interact with a generative AI model, estimate emotion, adjust candidate policies, and refine internal control based on feedback.

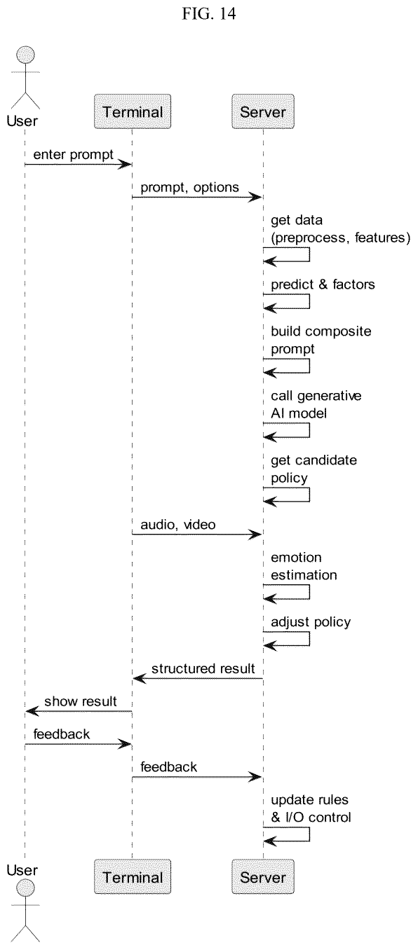

The following describes the processing flow using FIG. 14.

### Step 1:

User operates the terminal to input a prompt sentence and optional parameters. User views an input screen on the terminal, enters a natural-language prompt sentence such as “Propose a detailed marketing and pricing strategy to increase next quarter's revenue by 20%. Use my past three years of sales data and current market trends, and keep risk at a moderate level.”, and selects options such as target region or product group. Input is the user's prompt sentence and option selections. Output is a structured input event containing the text and options.

### Step 2:

Terminal converts the input event into a request message and transmits it to the server. Terminal takes the prompt sentence and options, serializes them into a structured format, attaches metadata such as a user identifier and time stamp, and opens a secure network connection to the server. Input is the structured input event from Step 1. Output is a network request message delivered to the server.

### Step 3:

Server receives the request message and parses instruction information. Server reads the incoming message from the network interface, verifies integrity and authorization, and extracts fields such as the prompt sentence, user identifier, and option values. Input is the network request message from Step 2. Output is an internal instruction object that holds the prompt sentence and associated parameters in memory.

### Step 4:

Server acquires business-related information corresponding to the instruction object. Server analyzes the prompt sentence and options to determine required data domains, constructs database queries for internal performance information, and sends interface requests to external data providers for environment trend information and competitor information. Input is the instruction object specifying time horizons, regions, and products. Output is a collection of raw data tables retrieved from internal storage and external sources.

### Step 5:

Server preprocesses the acquired data to form analyzable data formats. Server loads each raw data table into in-memory table objects, scans for missing values, calculates replacement values, removes or adjusts outliers based on statistical thresholds, and applies normalization to numerical columns. Input is the collection of raw data tables from Step 4. Output is a set of cleaned and normalized tables ready for learning-processing algorithms.

### Step 6:

Server constructs feature vectors and target variables for learning-processing algorithms. Server selects relevant columns from the cleaned tables, generates derived attributes such as moving averages or lagged indicators, encodes categorical attributes into numerical form, and aligns features with target variables such as future sales. Input is the cleaned and normalized tables from Step 5. Output is a feature matrix and an associated target vector.

### Step 7:

Server applies learning-processing algorithms to compute prediction information. Server loads trained model parameters, feeds the feature matrix into the model, performs forward computations through the model layers, and calculates predicted values for each record. Input is the feature matrix and model parameters from storage. Output is prediction information such as forecasted performance metrics per segment.

### Step 8:

Server computes influence-factor information from the models and data. Server evaluates importance scores of each feature using methods such as gradient-based sensitivity, permutation-based importance, or model-derived weights, and aggregates these scores into human-readable rankings. Input is the feature matrix, prediction information, and model structure. Output is influence-factor information specifying which factors most strongly impact predicted outcomes.

### Step 9:

Server constructs context information from prediction and influence-factor information. Server summarizes key predictions, selects top-ranked influence factors based on importance thresholds, converts numerical results into descriptive strings, and organizes this content into structured segments. Input is prediction information and influence-factor information from Steps 7 and 8. Output is a context object containing textual and structured descriptions of the current situation.

### Step 10:

Server generates a composite prompt sentence for a generative AI model. Server takes the user's original prompt sentence from the instruction object, appends or embeds context segments describing predictions and key factors, and applies templates to produce a single text sequence or structured instruction for the generative AI model. Input is the original prompt sentence and the context object from Step 9. Output is a composite prompt sentence that conditions the generative AI model on both user intent and computed context.

### Step 11:

Server sends the composite prompt sentence to the generative AI model and obtains response information. Server packages the composite prompt into a model-specific request, sets generation parameters such as maximum length and temperature, and transmits the request through an interface to the generative AI engine. Server receives the generated text output, parses it into logical sections, and identifies parts corresponding to candidate business policies and explanatory content. Input is the composite prompt sentence from Step 10. Output is response information containing at least one candidate business policy and its explanation.

### Step 12:

Terminal captures multimodal data related to user emotion during interaction. Terminal records audio from the microphone and video frames from the camera while user reads or reacts to the displayed content, encodes these signals into digital form, and batches or streams them to the server. Input is the physical speech and facial expressions of user. Output is a sequence of audio samples and image frames transmitted to the server.

### Step 13:

Server performs emotion estimation using the received multimodal signals. Server extracts acoustic features such as pitch and energy from audio, extracts visual features such as facial landmarks from images, inputs these features into trained emotion classification models, and fuses the results to estimate emotion categories and intensities. Input is the audio samples and image frames from Step 12. Output is emotion-state information indicating the current emotional state of user or participants.

### Step 14:

Server adjusts the candidate business policy based on emotion-state information. Server analyzes the emotion-state information to detect conditions such as anxiety or skepticism, applies rule-based transformations or issues a secondary request to the generative AI model to revise tone and content, and merges revisions with the original candidate policy to form a corrected business policy. Input is response information from Step 11 and emotion-state information from Step 13. Output is a corrected business policy that reflects both analytical context and emotional context.

### Step 15:

Server formats structured information for presentation at the terminal. Server organizes the corrected business policy, numerical predictions, key influencing factors, and emotion annotations into a structured response object, assigns presentation priorities, and converts the content into a format suitable for rendering in a graphical interface. Input is the corrected business policy and associated analytical data from Steps 7, 8, and 14. Output is structured output information ready to be sent to the terminal.

### Step 16:

Terminal receives the structured output information and renders it to user. Terminal parses the structured content, creates visual elements such as headings, bullet lists, charts, and icons, and displays the corrected business policy along with supporting metrics and emotion cues on the display. Input is the structured output information from Step 15. Output is a rendered user interface showing the recommended policy and data context.

### Step 17:

User evaluates the displayed corrected business policy and provides feedback. User reads the recommendations, compares them with expectations or constraints, and interacts with input controls to rate the usefulness, approve or reject proposals, and type free-form comments describing perceived strengths or deficiencies. Input is the rendered user interface from Step 16. Output is user-generated evaluation values and free-description text.

### Step 18:

Terminal packages user feedback and sends it to the server. Terminal collects evaluation scores, selection flags, and comment text from user interactions, associates them with identifiers for the corresponding policy and prompt, and transmits this feedback as a structured message over the network. Input is the evaluation and comments from Step 17. Output is a feedback message delivered to the server.

### Step 19:

Server stores feedback information and updates internal control logic. Server writes feedback records into a persistent store, analyzes text comments to detect sentiment and recurring themes, correlates feedback with used prompt structures and model parameters, and adjusts composite prompt generation rules and generative AI interaction settings accordingly. Input is the feedback message from Step 18 and historical control parameters. Output is an updated configuration for prompt generation and model input/output control that will be applied to future processing cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

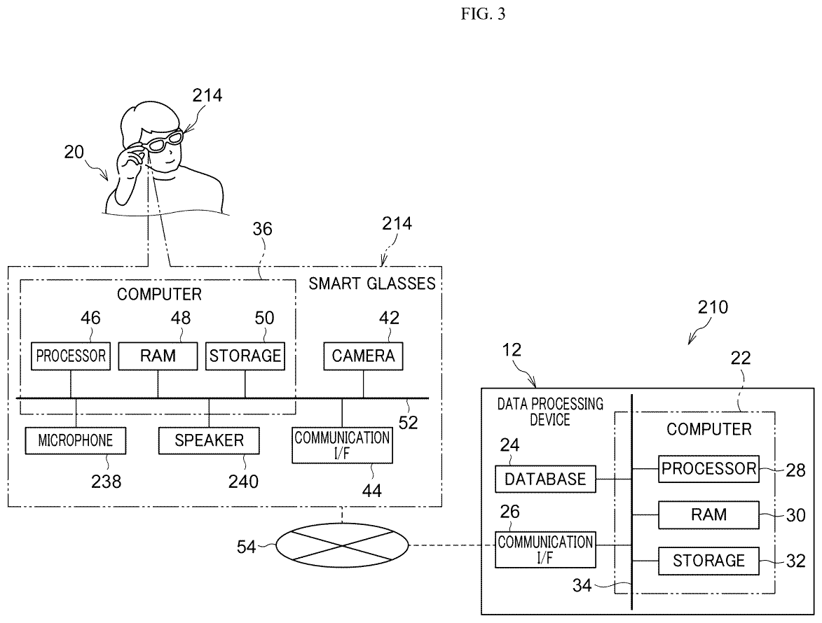

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

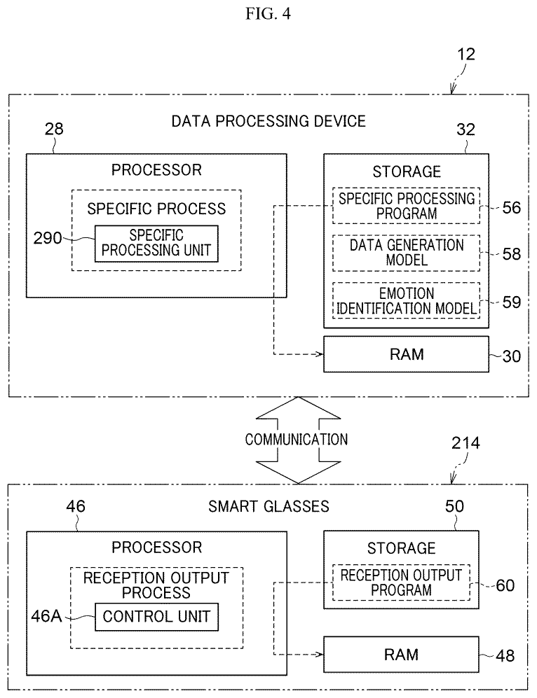

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

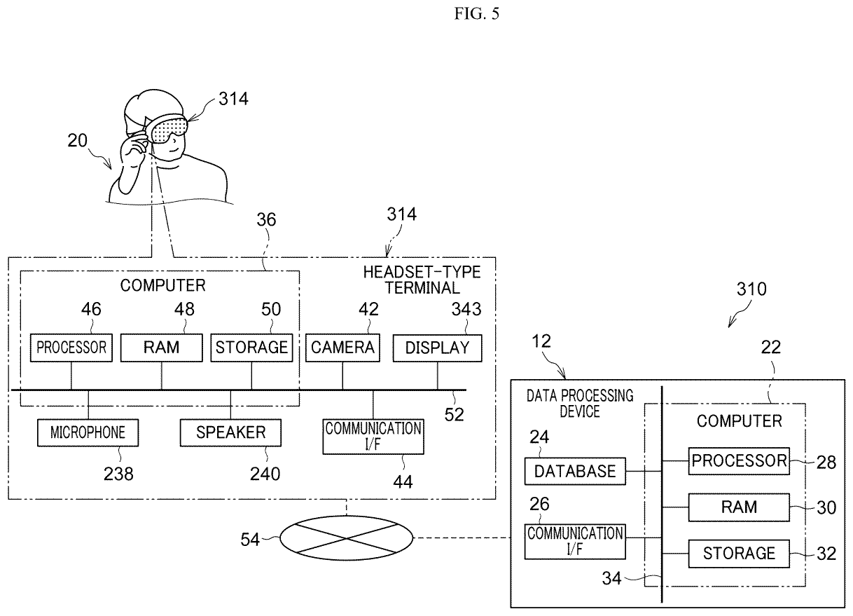

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

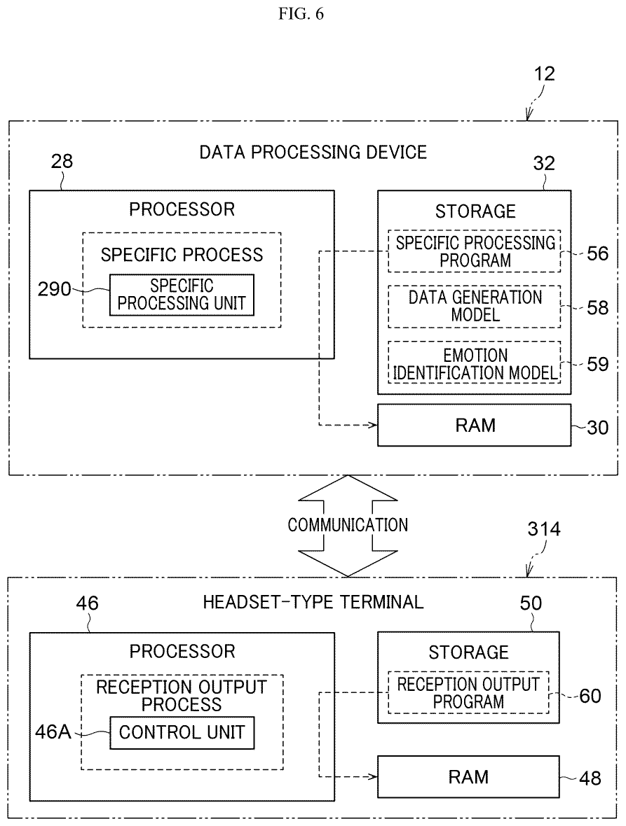

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

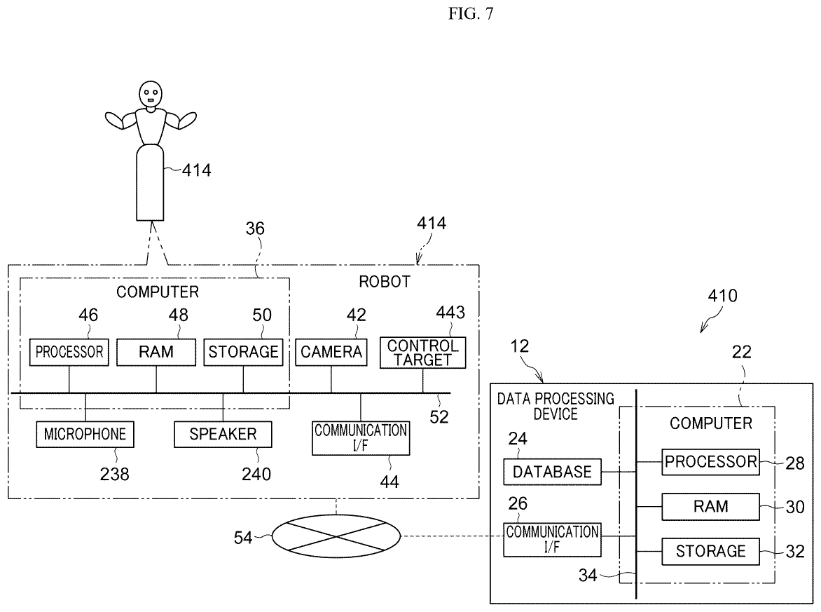

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

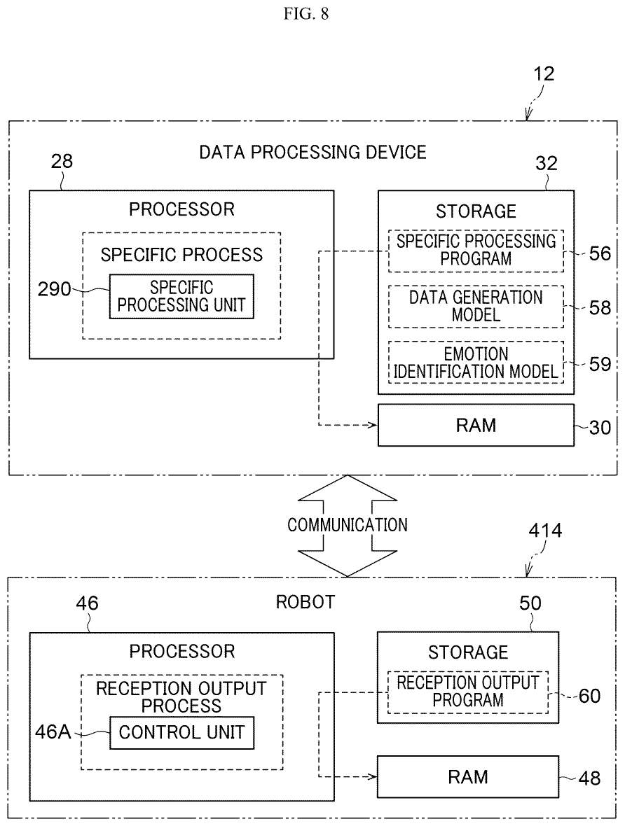

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

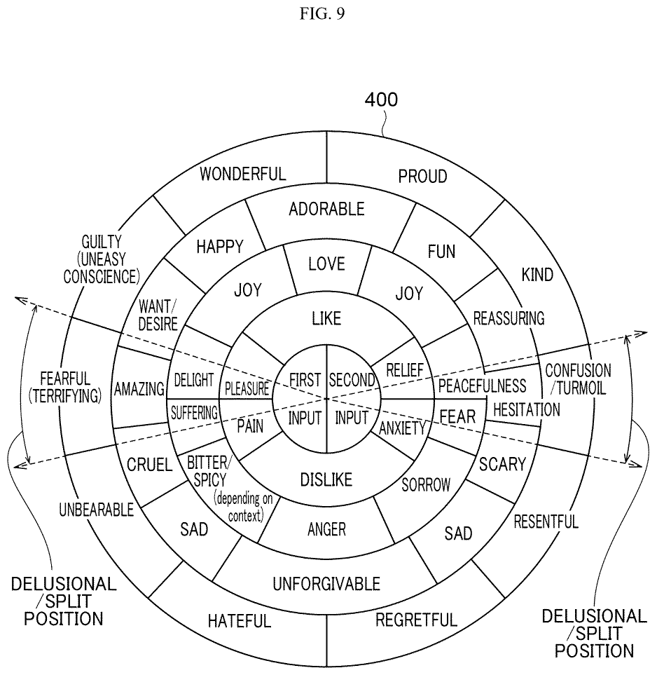

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

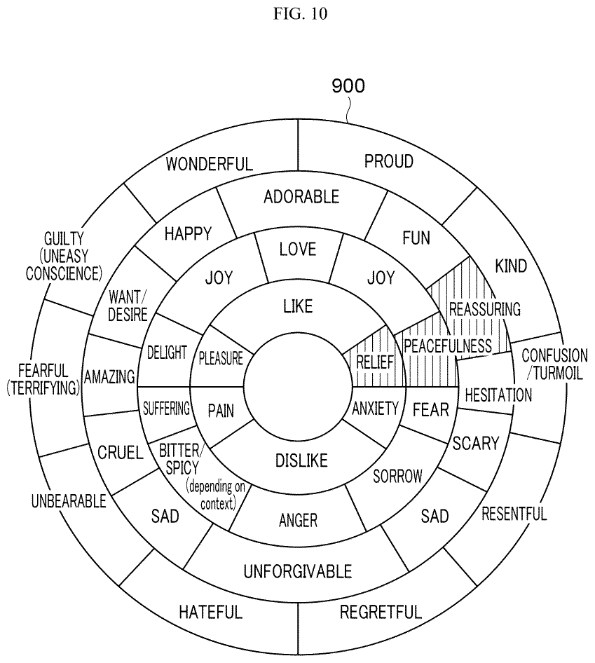

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire data including past performance information, market trend information, and competitor information from an external storage device and through a communication network, and collect the data by using a data acquisition interface,
convert the collected data into a numerical data set suitable for machine learning processing by storing the collected data in a tabular data structure and performing preprocessing including missing-value completion, outlier removal, normalization, and encoding, by using a data formatting unit,
identify factors affecting management indicators by executing, on an information processing apparatus, a machine learning algorithm that constitutes a prediction model or a classification model, using the numerical data set obtained by the data formatting unit as input, and performing numerical computation processing and parameter optimization processing, by using a factor identification unit,
generate a prompt sentence by a prompt generation unit, the prompt sentence including a role definition, an analysis summary, constraint conditions, and an output format, based on factor information obtained by the factor identification unit and management objective information,
generate a management strategy proposal by a management strategy generation unit by executing a generative artificial intelligence model using the prompt sentence generated by the prompt generation unit as input, and performing matrix operation processing on internal parameters and text generation processing,
transmit the management strategy proposal generated by the management strategy generation unit to a terminal device, and present the management strategy proposal to a user through a display interface, by using a presentation unit,
receive evaluation information and comment information transmitted from the terminal device as feedback information, analyze the feedback information to update the constraint conditions and generation rules of the prompt sentence, and further improve output characteristics of the management strategy generation unit by retraining or fine-tuning the generative artificial intelligence model or a control parameter thereof using the feedback information as training data, by using a model improvement unit,
acquire emotion information of the user by executing emotion analysis processing by an emotion acquisition unit, and adjust at least one of output content and expression format of the prompt generation unit and the management strategy generation unit according to the emotion information acquired by the emotion acquisition unit, by using an emotion reflection unit.

### (Supplementary 2)

The system according to supplementary 1,
wherein the processor is configured to execute generation processing of the management strategy proposal by the system in combination with a decision-making process of a human management decision-making organization, and present objective and continuous analysis results and strategy proposals to the management decision-making organization so as to realize a new management operation form.

### (Supplementary 3)

The system according to supplementary 1,
wherein the processor is configured to provide the management strategy proposal generated by the system as a resolution document to a decision-making body involved in corporate governance, and perform strategy proposal in parallel with members of the decision-making body so as to impart independence and tension to the decision-making body.

### Application Example 1

### (Supplementary 1)

A system comprising a processor,
wherein the processor is configured to
acquire, from an information management infrastructure stored in a storage device, historical information including past performance information, transaction information, and demand information, and external environment information including market trend information and competitive situation information, and to convert the historical information and the external environment information into structured tabular analysis information,
perform, on the structured tabular analysis information, a preprocessing process including missing-value processing, outlier processing, aggregation processing, time-series processing, and encoding processing by using a data processing program having a statistical processing function and a feature generation function, and generate feature information relating to demand prediction, inventory state, price level, and sales promotion state,
construct a prediction model by using a learning program with the feature information as input information, and, by using the prediction model, generate prediction information including future demand, sales indicators, inventory indicators, and price elasticity indicators for items or services,
set an objective function and constraint conditions relating to inventory levels, price levels, and sales promotion measures on the basis of the prediction information and the feature information, and calculate strategy candidates including replenishment quantities, candidate sales prices, and candidate sales promotion measures,
input numerical information and structured information including the replenishment quantities, the candidate sales prices, and the candidate sales promotion measures into a generative information processing model having a natural language generation function, and generate, as natural-language descriptions, management strategy proposals including inventory management policies, pricing policies, and sales promotion policies for an electronic transaction platform,
automatically generate a prompt sentence to be input to the generative information processing model, on the basis of the prediction information and output information of the strategy candidate calculation, and include in the prompt sentence condition information relating to the inventory levels, the price levels, and the sales promotion measures,
receive constraint condition information and priority information from a user operation apparatus, reflect the constraint condition information and the priority information in the objective function and the constraint conditions, re-execute the strategy candidate calculation, and, on the basis of output information after the re-execution, update the prompt sentence and the management strategy proposals, and
acquire evaluation information and feedback information from a user, and, by using the evaluation information and the feedback information for relearning of the prediction model and the generative information processing model, continuously improve accuracy of the demand prediction and accuracy of generation of the management strategy proposals.

### (Supplementary 2)

The system according to supplementary 1,
wherein the processor is configured to present the management strategy proposals in combination with elements forming a human decision-making body, and to use the management strategy proposals as decision material for the decision-making body, thereby realizing a new business operation scheme.

### (Supplementary 3)

The system according to supplementary 1,
wherein the processor is configured to treat the management strategy proposals as a virtual decision-making element that is given a position equivalent to a decision authority within an organizational management mechanism, and to cause the virtual decision-making element to participate in an actual decision-making process, thereby adding creativity and tension to the management mechanism.

### Example 2

### (Supplementary 1)

A system comprising a processor,
wherein the processor is configured to
collect past business information, external environment information, and other organization information, and to convert collected information into structured information that is processable by information analysis processing,
perform preprocessing on the structured information, the preprocessing including missing-value completion processing, outlier removal processing, and format unification processing, and generate summary indicators and summary description information from preprocessed information,
receive a prompt sentence input in natural language by a user on the basis of the summary indicators and the summary description information,
generate context information by combining the prompt sentence and the summary description information, operate a generative information processing model using the context information as input, and generate natural language output information including organization management policy proposals,
analyze the natural language output information, extract and structure a plurality of policy proposals, numerical proposal information corresponding to each policy proposal, and assumption information, and store structured information,
present the natural language output information and the structured information on an information display device, and acquire evaluation information and opinion information by the user as feedback information, and
store the feedback information in association with the prompt sentence, the context information, and the natural language output information, and update at least one of the generative information processing model and control conditions of context information generation processing on the basis of stored results.

### (Supplementary 2)

The system according to supplementary 1,
wherein the processor is configured to
distribute input and output of the prompt sentence, the structured information, and the summary description information between a management information processing apparatus and a communication terminal apparatus, receive input of the prompt sentence and input of the feedback information by the user at the communication terminal apparatus, and perform the preprocessing, the context information generation, and operation of the generative information processing model at the management information processing apparatus.

### (Supplementary 3)

The system according to supplementary 1,
wherein the processor is configured to
execute aggregation processing and classification processing on the feedback information to extract evaluation patterns indicating usefulness tendencies or mismatch tendencies of specific policy proposals, and dynamically change at least one of input conditions for the generative information processing model, output post-processing conditions, and model selection conditions on the basis of the evaluation patterns.

### Application Example 2

### (Supplementary 1)

A system comprising a processor,
wherein the processor is configured to
acquire business-related information including performance information, environment trend information, and competitor information from at least one external information source and at least one internal information source,
convert the acquired business-related information into an analyzable data format by performing preprocessing including missing-value completion, outlier removal, and normalization,
apply a learning-processing algorithm to the preprocessed data to calculate prediction information and influence-factor information, and identify, as the influence-factor information, factors that affect a business policy,
receive, from a user terminal, instruction information including a prompt sentence, and generate a composite prompt sentence for input to a generative AI model having a natural-language generation function, the composite prompt sentence being based on the instruction information and on context information including the prediction information and the influence-factor information,
input the composite prompt sentence to the generative AI model and obtain, from the generative AI model, response information including a candidate business policy and an explanation of a basis for the candidate business policy,
execute an emotion estimation model using at least one of voice information and image information obtained from at least one of the user terminal and a measurement apparatus, and generate emotion-state information representing an emotion state of at least one of a user and a participant,
adjust at least one of content and expression of the candidate business policy included in the response information in accordance with the emotion-state information, and generate a corrected business policy that takes the emotion state into account,
transmit structured information including the corrected business policy and related numerical information to the user terminal, and generate output information for display control at the user terminal, and
store feedback information including evaluation information and free-description information regarding the corrected business policy, the feedback information being obtained from the user terminal, and update at least one of generation rules of the composite prompt sentence and input/output control with the generative AI model based on the feedback information.

### (Supplementary 2)

The system according to supplementary 1,
wherein the processor is configured to present the corrected business policy in parallel with, or in a complementary manner to, a conventional decision-making mechanism constituted by human decision-making entities, and to realize a new business-operation scheme through cooperation with the conventional decision-making mechanism.

### (Supplementary 3)

The system according to supplementary 1,
wherein the processor is configured to function as a virtual decision-making entity that presents the corrected business policy in a position equivalent to that of an external member of a decision-making organ of an organization, and to add creativity and tension to the decision-making organ through involvement of the virtual decision-making entity.

What is claimed is:

1. A system comprising:
circuitry configured to:
acquire, via a communication interface coupled to a packet-switched network, heterogeneous data comprising first performance data, second trend data, and third comparative data from at least one data source, store the acquired data in a tabular data structure in a storage device, and apply automated preprocessing comprising missing-value completion, outlier removal, normalization, and encoding to generate a numerical dataset;
execute at least one machine learning algorithm on the numerical dataset constituting a prediction model or a classification model, performing numerical computation and parameter optimization to identify factors affecting at least one performance indicator and generate factor data;
automatically construct, based on the factor data and objective data, a prompt sentence comprising at least a role definition, an analysis summary, constraint conditions, and an output format specification;
input the prompt sentence to a generative neural network model and execute matrix operations on internal parameters of the generative neural network model to generate a text-based strategy proposal;
transmit the strategy proposal to a terminal device, receive feedback data comprising evaluation data and annotation data from the terminal device, analyze the feedback data to update at least one of the constraint conditions and generation rules for the prompt sentence, and retrain or fine-tune at least one of the generative neural network model or the machine learning algorithm using the feedback data; and
apply emotion analysis processing to user interaction data to generate an emotion state parameter, and adjust at least one of a content specification or an expression format specification of the prompt sentence based on the emotion state parameter.

2. The system according to claim 1, wherein the circuitry is configured to apply the automated preprocessing by executing a missing-value completion algorithm that fills null entries using statistical imputation, an outlier removal algorithm that eliminates records exceeding a deviation threshold, a normalization algorithm that scales numerical values to a unit range, and an encoding algorithm that converts categorical fields to numerical representations.

3. The system according to claim 2, wherein the circuitry is configured to apply the machine learning algorithm by training a prediction model on a training partition of the numerical dataset, computing feature importance scores using a gradient-based attribution method, and selecting factors with feature importance scores exceeding a significance threshold as the factor data.

4. The system according to claim 3, wherein the circuitry is configured to construct the prompt sentence by selecting a prompt template based on an objective type parameter, substituting the factor data and objective data into the prompt template to produce the analysis summary, and appending constraint conditions specifying output length, response format, and analytical scope.

5. The system according to claim 4, wherein the circuitry is configured to parse the text-based strategy proposal received from the generative neural network model to extract structured proposal sections, verify format compliance of each section against the output format specification, and regenerate non-compliant sections by supplying a correction prompt sentence to the generative neural network model.

6. The system according to claim 5, wherein the circuitry is configured to apply a feedback analysis algorithm to the feedback data to identify categories of user corrections or evaluations, update the constraint conditions and generation rules by modifying prompt template parameters based on the identified correction categories, and apply the updated constraint conditions in a subsequent prompt sentence construction cycle.

7. The system according to claim 6, wherein the circuitry is configured to construct supplemental training data from the feedback data by pairing the prompt sentence with a modified strategy proposal reflecting the evaluation data and annotation data, and fine-tune the generative neural network model using the supplemental training data via a gradient-based optimization algorithm.

8. The system according to claim 1, wherein the circuitry is configured to classify the emotion state parameter into one of a plurality of emotional state categories, select an expression adjustment strategy from a plurality of expression adjustment strategies based on the classified emotional state category, and modify the expression format specification of the prompt sentence to reflect the selected expression adjustment strategy.

9. The system according to claim 8, wherein the circuitry is configured to detect a change in the emotion state parameter exceeding a state-change threshold between consecutive processing cycles, regenerate the prompt sentence incorporating the updated emotion state parameter, and supply the regenerated prompt sentence to the generative neural network model.

10. The system according to claim 1, wherein the circuitry is configured to generate a plurality of candidate prompt sentences each incorporating different subsets of the factor data and different constraint conditions, input each candidate prompt sentence to the generative neural network model to generate a plurality of candidate strategy proposals, evaluate each candidate strategy proposal using a quality metric computed from the objective data, and select the highest-scoring candidate strategy proposal for transmission to the terminal device.

11. The system according to claim 10, wherein the circuitry is configured to compute the quality metric by applying a multi-objective scoring function measuring alignment between each candidate strategy proposal and the objective data, consistency with the factor data, and adherence to the constraint conditions.

12. The system according to claim 1, wherein the circuitry is configured to periodically re-execute the machine learning algorithm on updated numerical datasets incorporating newly acquired first performance data, second trend data, and third comparative data, recompute the factor data, and regenerate the prompt sentence incorporating the updated factor data.

13. The system according to claim 12, wherein the circuitry is configured to detect a statistically significant change in the factor data between consecutive executions of the machine learning algorithm, trigger a prompt sentence regeneration cycle, supply the regenerated prompt sentence to the generative neural network model, and transmit an updated strategy proposal to the terminal device.

14. The system according to claim 1, wherein the circuitry is configured to store a history of prompt sentences, strategy proposals, feedback data, and emotion state parameters in the storage device indexed by a session identifier and a timestamp, and supply stored history data as context in subsequent prompt sentence construction to maintain consistency of strategy proposals across processing cycles.

15. The system according to claim 14, wherein the circuitry is configured to apply a trend analysis algorithm to the stored strategy proposals and associated feedback data to identify recurring user evaluation patterns, adjust prompt template constraint conditions based on the identified patterns, and store the adjusted constraint conditions in the storage device for application to subsequent prompt sentence construction.

16. The system according to claim 1, wherein the circuitry is configured to generate a simulation prompt sentence incorporating the factor data and a set of hypothetical objective parameter values, input the simulation prompt sentence to the generative neural network model to generate a simulated strategy proposal, and transmit the simulated strategy proposal to the terminal device for scenario analysis.

17. The system according to claim 16, wherein the circuitry is configured to apply a sensitivity analysis algorithm to the simulated strategy proposal by varying individual factor data values within a predetermined range, computing a sensitivity score for each varied factor, and incorporating the highest-sensitivity factors into the constraint conditions of subsequent prompt sentences.

18. A system comprising:
circuitry configured to:
acquire, via a communication interface coupled to a packet-switched network, heterogeneous data from at least one data source, apply automated preprocessing to generate a numerical dataset, and execute a machine learning algorithm on the numerical dataset to generate factor data identifying factors affecting at least one performance indicator;
construct a prompt sentence comprising a role definition, an analysis summary derived from the factor data, constraint conditions, and an output format specification, and input the prompt sentence to a generative neural network model to generate a text-based strategy proposal;
transmit the strategy proposal to a terminal device, receive feedback data, and update at least one of the constraint conditions and generation rules based on the feedback data; and
apply emotion analysis processing to user interaction data to generate an emotion state parameter, and adjust at least one of a content specification or an expression format specification of the prompt sentence based on the emotion state parameter.

19. The system according to claim 18, wherein the circuitry is configured to retrain or fine-tune the generative neural network model or the machine learning algorithm using the feedback data by constructing supplemental training data pairing the prompt sentence with a modified strategy proposal and applying a gradient-based optimization algorithm.

20. A method performed by circuitry, the method comprising:
acquiring, via a communication interface coupled to a packet-switched network, heterogeneous data comprising first performance data, second trend data, and third comparative data from at least one data source, storing the acquired data in a tabular data structure in a storage device, and applying automated preprocessing comprising missing-value completion, outlier removal, normalization, and encoding to generate a numerical dataset;
executing at least one machine learning algorithm on the numerical dataset constituting a prediction model or a classification model, performing numerical computation and parameter optimization to identify factors affecting at least one performance indicator and generating factor data;
automatically constructing, based on the factor data and objective data, a prompt sentence comprising at least a role definition, an analysis summary, constraint conditions, and an output format specification;
inputting the prompt sentence to a generative neural network model and executing matrix operations on internal parameters of the generative neural network model to generate a text-based strategy proposal;
transmitting the strategy proposal to a terminal device, receiving feedback data comprising evaluation data and annotation data from the terminal device, analyzing the feedback data to update at least one of the constraint conditions and generation rules for the prompt sentence, and retraining or fine-tuning at least one of the generative neural network model or the machine learning algorithm using the feedback data; and
applying emotion analysis processing to user interaction data to generate an emotion state parameter, and adjusting at least one of a content specification or an expression format specification of the prompt sentence based on the emotion state parameter.
